(19) United States
(12) Patent Application Publication
(10) Pub. No.: US 2026/0131460 A1
(43) Pub. Date: May 14, 2026

(54) ELECTROADHESION CONTROL OF ROTARY MOTION

(71) Applicant: THE UNIVERSITY OF WESTERN ONTARIO, London, Ontario (CA)

(72) Inventors: Mehrdad RAJI KERMANI, London, Ontario (CA); Navid FEIZI, London, Ontario (CA); Rajnikant PATEL, London, Ontario (CA)

(21) Appl. No.: 19/119,045

(22) PCT Filed: Oct. 6, 2023
(86) PCT No.: PCT/CA2023/000026

§ 371 Date: Apr. 7, 2025

Related U.S. Application Data
(60) Provisional application No. 63/378,729, filed on Oct. 7, 2022.

(51) Int. Cl. B25J 9/16; A61H 3/00; B25J 9/00

(52) U.S. Cl. CPC B25J 9/1633; B25J 9/0006; A61H 3/00

(57) ABSTRACT

A device for electroadhesion control of motion, the device including: an aligned first plate and second plate, a first surface of the first plate aligned in substantially parallel facing opposition to a second surface of the second plate, the first surface and second surface forming a dry sliding friction contact pair that defines an electroadhesion interface therebetween; a dielectric material disposed on at least one of the first surface or the second surface; the contact pair of the first surface and second surface exhibiting electroadhesion based in part on a sufficient electrical field generated across the contact pair and the electroadhesion interface to achieve electrostatic attraction between the contact pair to cause a frictional force therebetween; a polarity modulator alternating the electrical field multiple times between the contact pair. Also described is a method for electroadhesion control of motion.

### BACKGROUND OF THE INVENTION

### Field of the Invention

The present invention relates to transfer or resistance of rotary motion or torque between two or more plates, and more particularly to electrostatic adhesive control of rotary motion or torque between two or more plates in a clutch or brake device, apparatus, system or method.

### Description of the Related Art

Electrostatic force has been considered for control of motion in robotics and in particular in robotics that interact with human anatomy, such as robotic exoskeletons or rehabilitation robots.

The electrostatic force has been harnessed to generate electroadhesion, mostly for object handling and robotic locomotion applications. In contrast to the magnetic field, the required energy to generate an electric field is very small, and there is no need for heavy parts and fluid (which may have a leakage problem). The electrostatic force, therefore, shows high potential to be exploited for electroadhesive control of motion, in a low-space, lightweight, and energy-efficient manner.

A recognized problem in using electrostatic force for electroadhesion of moving surfaces, is that the electroadhesion force degrades with time due to residual charges, resulting in time-dependent dynamics of the electroadhesion force, which makes such an implementation complex, particularly for rotary motion, and even more particularly for rotary components that support multiple consecutive 360 degree revolutions as compared to a limited revolute joint that typically supports less than a 360 degree range of motion.

Accordingly, there is a continuing need for an alternative device, apparatus, system or method providing electroadhesion control of rotary motion.

### SUMMARY OF THE INVENTION

In an aspect there is provided, a device for electroadhesion control of rotary motion, the device comprising:
a shaft;
a first plate and second plate coupled to the shaft, a first surface of the first plate aligned in substantially parallel facing opposition to a second surface of the second plate, the first surface and second surface forming a dry sliding friction contact pair that defines an electroadhesion interface therebetween;
a dielectric material disposed on at least one of the first surface or the second surface;
the contact pair of the first surface and second surface exhibiting electroadhesion based in part on a sufficient electrical field generated across the contact pair and the electroadhesion interface to achieve electrostatic attraction between the contact pair to cause a frictional force therebetween;
a polarity modulator alternating the electrical field multiple times per revolution of the contact pair.

In another aspect there is provided, a method for electroadhesion control of rotary motion, the method comprising:
coupling a first plate and second plate to a shaft;
aligning a first surface of the first plate in substantially parallel facing opposition to a second surface of the second plate, the first surface and second surface forming a dry sliding friction contact pair that defines an electroadhesion interface therebetween;
configuring at least one of the first surface or the second surface with a dielectric material;
generating an electrical field across the contact pair and the electroadhesion interface sufficient to achieve electrostatic attraction between the contact pair to cause a frictional force therebetween so that the contact pair of the first surface and second surface exhibit electroadhesion;
alternating the electrical field multiple times per revolution of the contact pair with a polarity modulator.

In another aspect there is provided, a device for electroadhesion control of rotary motion, the device comprising:
a shaft;
a first plate and second plate coupled to the shaft, a first surface of the first plate aligned in substantially parallel facing opposition to a second surface of the second plate, the first surface and second surface forming a dry sliding friction contact pair that defines an electroadhesion interface therebetween;
a dielectric material disposed on at least one of the first surface or the second surface;
the contact pair of the first surface and second surface exhibiting electroadhesion based in part on a sufficient electrical field generated across the contact pair and the electroadhesion interface to achieve electrostatic attraction between the contact pair to cause a frictional force therebetween;
a third plate exerting a constant pressure on at least one of the first plate or the second plate to bias the first and second plate towards each other.

In another aspect there is provided, a device for electroadhesion control of linear motion, the device comprising:
a first plate and second plate coupled to a housing, a first surface of the first plate aligned in substantially parallel facing opposition to a second surface of the second plate, the first surface and second surface forming a dry sliding friction contact pair that defines an electroadhesion interface therebetween;
a dielectric material disposed on at least one of the first surface or the second surface;
the contact pair of the first surface and second surface exhibiting electroadhesion based in part on a sufficient electrical field generated across the contact pair and the electroadhesion interface to achieve electrostatic attraction between the contact pair to cause a frictional force therebetween;
a polarity modulator alternating the electrical field applied to the contact pair.

In further aspects, a system or an apparatus incorporating the device is provided.

In still further aspects, a system or an apparatus for executing the method is provided.

### BRIEF DESCRIPTION OF THE DRAWINGS

FIG. 1A shows a schematic of a minimal device for electroadhesion control of rotary motion between a first plate and a second plate. FIG. 1B shows the minimal device of FIG. 1A further including a pressure plate to bias the first and second plates towards each other.

FIG. 2 illustrates a perspective cross-section view of a rotary clutch device incorporating the adhesion control concept shown in FIG. 1, the cross-section cut along a central axis of an output shaft.

FIG. 3A shows a partial sectioned perspective view of a system incorporating the device shown in FIG. 2. FIG. 3B shows a perspective view of the system shown in FIG. 3A.

FIG. 4 shows a-schematic of the rotary electroadhesive clutch designed and validated in Experimental Example 1.

FIG. 5 shows a schematic of the disc configurations prepared in Experimental Example 1: (a) Pair 1; (b) Pair 1; (c) Pair 3.

FIG. 6 shows photographs of configurations of the clutch discs tested in Experimental Example 1: (a) Pair 1 stator disc; (b) Pair 1 rotor disc; (c) Pair 2 stator disc; (d) Pair 2 rotor disc; (e) Pair 3 stator disc; (f) Pair 3 rotor disc.

FIG. 7 shows a rotary electroadhesive clutch test-setup in Experimental Example 1.

FIG. 8 shows output torque for dielectric against dielectric friction disc pair #1 (dashed line graph) and #2 (solid line graph) under DC and AC (50 Hz) activations in Experimental Example 1. The active region is shaded in gray.

FIG. 9 shows output torque for disc pair #3 (dielectric against steel friction) under DC and AC activations in Experimental Example 1. The active region is shaded in gray.

FIG. 10 shows clutch performance under 300 Hz AC activation in Experimental Example 1. The clutch was activated at t=10 s and was deactivated at t=130 s. The active region is shaded in gray. Dashed lines are the torque predicted by the model.

FIG. 11 shows averaged output torque (points) and proposed models (solid lines) for different activation voltages in AC mode in Experimental Example 1.

FIG. 12 shows output torque and input current for different frequencies of the activation voltage with 180˜V amplitude in Experimental Example 1.

FIG. 13 shows clutch performance under a DC activation in Experimental Example 1. The clutch was activated at t=10 s and was deactivated at t=190 s. The active region is shaded in gray. Dashed lines are the torque predicted by the model.

FIG. 14 shows current and power consumption of the clutch under DC and AC activations in Experimental Example 1.

FIG. 15 shows a one-DoF haptic device for pHRI in Experimental Example 1.

FIG. 16 shows a schematic of the haptic device and the controller architecture in Experimental Example 1.

FIG. 17 shows a physical human-robot interaction experimental results for the clutch input velocity of 15 RPM in Experimental Example 1: (a) Handle angle; (b) Desired and rendered torque; (c) Desired and rendered stiffness.

FIG. 18 shows a physical human-robot interaction experimental results for the clutch input velocity of 0 in Experimental Example 1: (a) Handle angle; (b) Desired and rendered torque; (c) Desired and rendered stiffness.

FIG. 19 shows a-schematic of the rotary electroadhesive clutch in Experimental Example 2.

FIG. 20 shows the test-setup for the rotary electroadhesive clutch in Experimental Example 2.

FIG. 21 shows a sample of a period of the positive and negative magnitudes PWM signal and expected clutch torque in Experimental Example 2. The solid graph shows the control signal. The dashed graph shows the instantaneous expected torque.

FIG. 22 show solid lines illustrating the experimental torque vs. time for different normal forces in Experimental Example 2. The normal force is applied at t=0. The dashed lines show the estimated torque associated with each normal force using the proposed friction model.

FIG. 23 shows identified parameters of the friction model in Experimental Example 2. Each graph shows the variation in the associated parameters with respect to the normal stress. (a) Stable torque vs. normal stress. (b) τ₁ vs. normal stress. (c) Friction coefficient vs. normal stress. (d) τ₂ vs. normal stress.

FIG. 24 shows identified parameters of friction model in Experimental Example 2. Each graph shows the variation in the associated parameters with respect to velocity. (a) Stable torque vs. normal stress. (b) τ₁ vs. normal stress. (c) τ₂ vs. normal stress.

FIG. 25 shows output torque under DC and AC activations in Experimental Example 2. The active region is shaded in gray.

FIG. 26-shows averaged experimental values (solid lines), standard deviation (highlighter areas), and the predicted torques using the proposed nonlinear model (dashed lines) for different input signals vs. time in Experimental Example 2. The legend shows the PWM duty cycle value. The written value close to each graph shows the RMSE of model estimation for each input signal. The amplitude of the input PWM signal was 300 V.

FIG. 27 shows clutch torque for different control signals in Experimental Example 2. The legend shows the PWM duty cycle value. The clutch activated at t=0 s. Solid lines illustrate the experimental torque. Dashed lines show the estimated torque calculated using the linear model.

FIG. 28 shows friction shear stress vs. applied electric field for EA actuators in literature and our EA clutch in Experimental Example 2. The square markers show linear actuators, and the triangle markers show rotational actuators. The hollow markers demonstrate adjustable actuators.

FIG. 29 shows a block diagram of the robust controller in Experimental Example 2.

FIG. 30 shows a step response of the clutch using the RC and PI controller in Experimental Example 2.

FIG. 31 shows a performance of the RC and PI controllers for a multi-sinusoidal trajectory comprised of harmonics ranging from 0.2 to 4 Hz in Experimental Example 2. Horizontal axes are time. (a) Torque. (b) Tracking error. (c) Control signal. (d) Power spectrum density of the of control signal.

FIG. 32 shows results of the frequency response in Experimental Example 2. (a) Amplitude of the response (dB). (b) Absolute tracking error (N·m).

FIG. 33 shows an elbow rehabilitation exoskeleton validation setup in Experimental Example 2.

FIG. 34 shows a control system diagram in Experimental Example 2. The light gray shows the impedance controller for active-resistive rehabilitation. The dark gray path shows the controller of the coordinative-assistive rehabilitation.

FIG. 35 shows results of the rehabilitation training experiments in Experimental Example 2. (a) Target and hand positions. (b) Position tracking error. (c) Desired and rendered interaction torque. (d) Torque tracking error.

FIG. 36 shows-absolute position tracking error of the rehabilitation training experiments in Experimental Example 2.

FIG. 37 shows a schematic of the discs in Experimental Example 3. Left: SED stator disc. Right: uniform rotor disc.

FIG. 38 shows a schematic of an electric field over the dielectric in Experimental Example 3. Gray color denotes the electric field going into the plane and checkboard regions denotes the electric field coming out of the plane.

FIG. 39 shows a dimension of a piece of segmented disc and the infinitesimal piece in Experimental Example 3.

FIG. 40 shows a resultant electric field around the dielectric before and after clutch activation in Experimental Example 3. Left: electric field around the dielectric at t=Os. Right: electric field around the dielectric at t=10 s. The unit of electric field is kV/mm and the unit of the axes is mm.

FIG. 41 shows Torque vs time for different velocities and number of segments in Experimental Example 3. The clutch was activated for 40 seconds with 200 V with a Step signal. Top: 1 RPM. Middle: 4 RPM. Bottom: 8 RPM.

FIG. 42 shows effect of the number of segments and velocity of rotation on the maximum torque in Experimental Example 3.

FIG. 43 shows a test setup in Experimental Example 3. Left: EA clutch test setup. Top right: stator disc. Bottom right: rotor disc.

FIG. 44 shows sample of the training data vs time in Experimental Example 3.

FIG. 45 shows an LSTM Network in Experimental Example 3.

FIG. 46 shows training loss vs epochs in Experimental Example 3.

FIG. 47 shows torque vs time for conventional DC mode and SED in Experimental Example 3. The clutch was active in the area shaded in gray.

FIG. 48 shows torque vs time for stairs input signal in Experimental Example 3.

FIG. 49 shows an analytical model, LSTM prediction, and the truth value for a part of the test data in Experimental Example 3. The horizontal axis is time in second.

FIG. 50 shows a schematic of a flexible disc integrating leaf springs.

FIG. 51 shows a plot of an average of the PSD of recorded noise for frequencies ranging from 50 to 2000 Hz. The dashed darker grey lines and dashed lighter grey lines demonstrate the determined natural frequencies of the stator and rotor disc, respectively.

FIG. 52 shows a plot of amplitude of recorded noise for frequencies ranging from 50 to 700 Hz.

FIG. 53 shows a schematic of the segmented plate in a linear configuration with FIG. 53A showing an exploded view showing electroadhesion interface contact surfaces of first and second plates, and FIG. 53B showing a side assembled view the first and second plates.

### DETAILED DESCRIPTION OF PREFERRED EMBODIMENTS

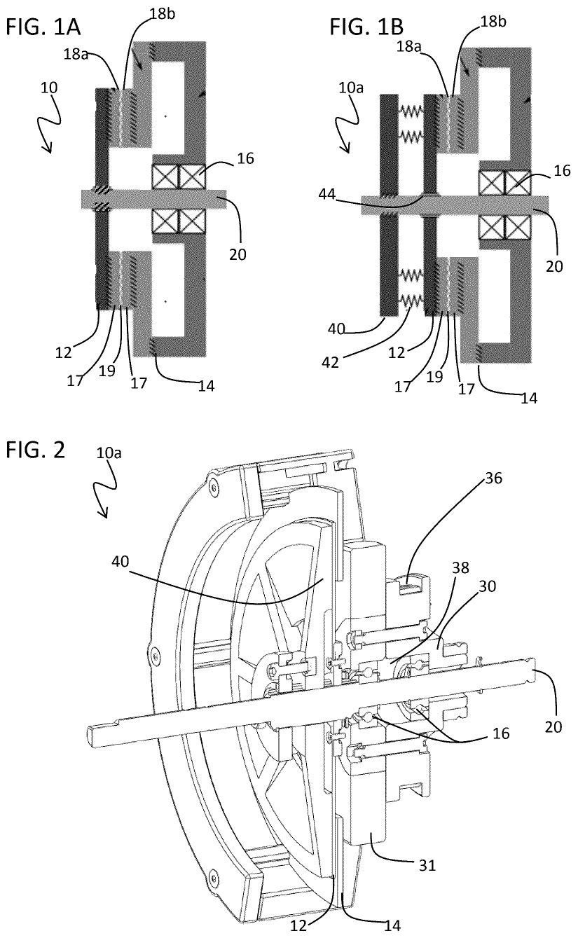

With reference to the drawings, electroadhesion control of rotary motion is described. A typical minimal implementation of electroadhesion control of rotary motion includes coupling a first plate and second plate to a shaft, the first plate presenting a first surface and the second plate presenting a second surface; aligning a first surface of the first plate in substantially parallel facing opposition to a second surface of the second plate, the first surface positioned to be close to or to abut the second surface, the first surface and second surface forming a dry sliding friction contact pair that defines an electroadhesion interface therebetween; typically at least one of the first surface or the second surface has been configured to be layered or coated with a dielectric material; generating an electrical field across the contact pair and the electroadhesion interface sufficient to achieve electrostatic attraction between the contact pair to cause a frictional force therebetween so that the contact pair of the first surface and second surface exhibit electroadhesion. The first and second plates differ with respect to rotational coupling with the shaft; for example at least one of the first and second plate is rotationally dependent to the shaft so that rotational motion is at least partially, and often fully, coincident with rotation of the shaft, while the other of the first and second plate is rotationally independent of the shaft and may be rotationally dependent to another shaft or to a housing or casing as may be desired for a specific implementation, such as a clutch configuration or a brake configuration, and may remain rotationally independent until sufficient electroadhesion is generated across the first and second surfaces and the electroadhesion interface located therebetween. Typically, electroadhesion control can be readily adapted as a clutch or a brake by modifying which of the first and second plates is rotationally-dependent to the shaft and which of the first and second plates is rotationally independent of the shaft in absence of electroadhesion force at the electroadhesion interface. An example of this typical minimal implementation is an electroadhesion controlled rotary device 10 illustrated schematically in FIG. 1A. As another example, a modification of FIG. 1A is an electroadhesion controlled rotary device 10a illustrated schematically in FIG. 1B, the modification including mounting of a third plate (referred to as a pressure plate) on the shaft, the pressure plate equipped with a plurality of compression springs that engage one of the first and second plates to slide the engaged first or second plate along an axial length of the shaft and thereby bias the first and second plates together to maintain a desired minimal gap at the electroadhesion interface of the first and second surfaces throughout rotation of shaft.

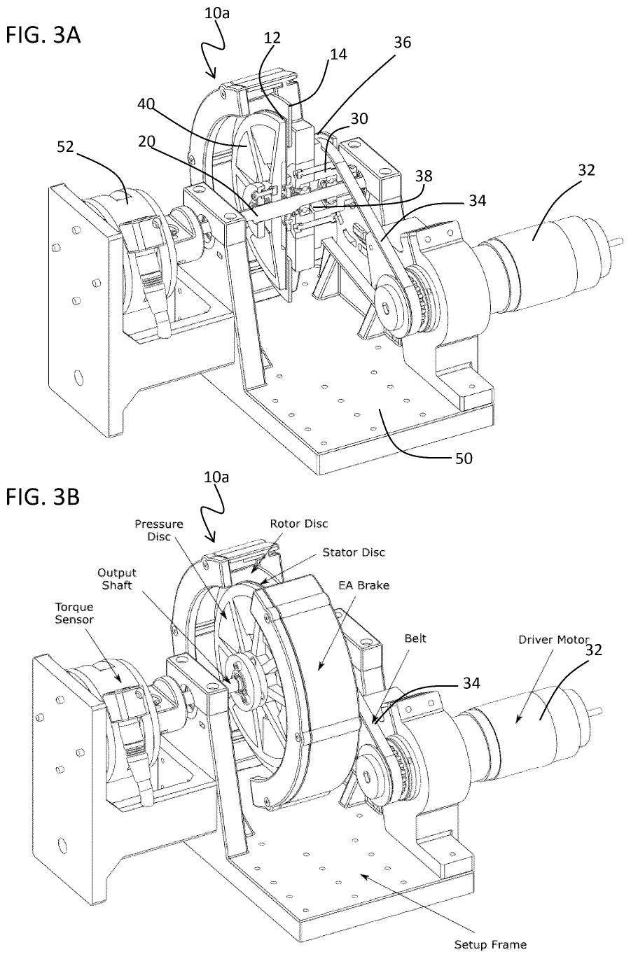

FIG. 2 illustrates a perspective cross-section view of an example of a clutch configuration that is fabricated according to the schematic illustrated in FIG. 1B. For ease of reference, in this example, the first plate 12 is a stator disc (ie., in this example the first plate and stator disc are used interchangeably, and are interchangeably labeled with reference number 12) that is rotationally fixed, and thus rotationally dependent, to an output shaft 20, while the second plate 14 is a rotor disc (ie., in this example the second plate and rotor disc are used interchangeably, and are interchangeably labeled with reference number 14) that is journaled with a suitable bearing 16 to the output shaft 20 and rotates independently of the output shaft 20 in absence of sufficient electroadhesion control at the electroadhesion interface between the first and second surfaces. The rotor disc 14 is rotationally fixed, and thus rotationally dependent, to an input shaft 30. More specifically, the rotor disc 14 is fixed to a mounting disc 31 which is in turn is fixed to the input shaft 30 which is journaled to the output shaft 20. In this example, both of the stator disc 12 and the rotor disc 14 are layered or coated with a dielectric material 17 to provide a first surface 18a and a second surface 18b of a contact pair of dielectric material of the stator and rotor discs that defines an electroadhesion interface 19; so that generating an electrical field across the contact pair and the electroadhesion interface 19 can achieve electrostatic attraction between the contact pair to cause a frictional force therebetween so that the contact pair of the first surface 18a and second surface 18b exhibit electroadhesion. As illustrated in FIG. 3A and FIG. 3B, the input shaft 30 is connected to a motor 32 with a transmission belt 34. The input shaft provides a circumferential groove 36 at its exterior surface to hold and engage the transmission belt 34. The input shaft is formed with an internal lumen 38 or channel that is sized and configured to be journaled to the output shaft 20 so that the input shaft 30 and the output shaft 20 are co-axial and so that the input shaft 30 is a rotational driver of the rotor disc 14 and both the input shaft 30 and the rotor disc 14 are rotationally independent of the output shaft 20 in absence of sufficient electroadhesion force at the electroadhesion interface.

A third plate 40 may also coupled to the output shaft 20 and the third plate 40 is a pressure disc 40 (ie., in this example the third plate and pressure disc are used interchangeably, and are interchangeably labeled with reference number 40) in the example illustrated in FIG. 2 and FIG. 3. The pressure disc 40 is fixed to the output shaft 20 and therefore is rotationally dependent to the output shaft 20. The pressure disc 40 is equipped with a plurality of compression springs 42 that engage the stator disc 12. The stator disc 12 is mounted to the output shaft 20 by a prismatic joint 44, and therefore pressure from the plurality of compression springs 42 biases the stator disc 12 to slide away from the pressure disc 40 along an axial length of the output shaft 20 and towards the rotor disc 14; thereby biasing the stator disc 12 and rotor disc 14 together to maintain a desired minimal gap at the electroadhesion interface throughout rotation of the input shaft 30, and throughout activation and deactivation events of electroadhesion force at the electroadhesion interface.

FIG. 3A shows an experimental setup for testing a clutch configuration of electroadhesion pair of the stator disc 12 and rotor disc 14, with the rotary device 10a including electroadhesion and rotary components and motor 32 and belt 34 drive components all mounted to a base 50 and its associated brackets and mounts, and with output shaft 20 connected to a torque sensor 52. Similarly, FIG. 3B shows an experimental setup for testing a brake configuration of electroadhesion pair of the stator disc 12 and rotor disc 14. FIG. 3A shows a cut away view for convenience of illustration of orientation of electroadhesion and rotary components, while FIG. 3B shows an assembled perspective view to show a housing of the rotary device. The clutch configuration and brake configuration differ simply based on grounding of the output shaft 20 in the brake configuration compared to a readily rotatable output shaft 20 in the clutch configuration.

The device, apparatus, system, and method for electroadhesion control of rotary motion have been validated by experimental testing. Experimental testing results demonstrate the ability of the device, apparatus, system and method to control a rotation of a first plate with rotation of a second plate by a reversible electrostatic coupling of the first plate to the second plate at a dry solid-solid electroadhesion interface. The following experimental examples are for illustration purposes only and are not intended to be a limiting description.

### Experimental Exemplification: Experimental Example 1

I. INTRODUCTION. With the development of interactive robotics that shares workspace and tasks with humans, such as exoskeletons and rehabilitation robots, the safety of robotic systems has become an important issue [1]. Controllers that consider the safety of the robotic system along with the transparency of interaction such as passivity controller [2]-[4] and wave variable controller [5] are two of the known methods that provide safety at the system control level. By designing the system based on passive components, such as clutches, safety can be assured at the mechanical level. Clutches have been used in several applications in robotics, particularly in physical human-robot interaction (pHRI) systems [6]-[8]. A clutch provides a limit on the torque/force coupling between the human and the source of mechanical energy leading to the intrinsic safety of the system. Clutches provide safety by separating the high-impedance actuator from the end effector, providing HRI safety in case of collisions or needed physical contacts for task-sharing [9], [10]. Constant damping clutches and on/off electromagnetic actuated clutches [11]-[12] are the most common types used in the literature mainly for emergency scenarios.

Using smart material and intelligent mechanisms, new types of clutches and actuators have been developed. Adjustable clutches allow a tunable amount of torque to be transferred thereby; they can be either used as part of the control loop of the actuator [13], or combined with passive springs as energy-storing actuators [8], or combined with motors (in parallel or series) as hybrid actuators [14]-[16].

Magnetic particle (MP) and magneto-rheological (MR) clutches are the two types of reputable torque adjustable clutches that work based on dry and viscous friction, respectively [15]-[19]. In MP clutches, the electromagnetic field generated by the coil that is integrated into the clutch affects the formation of the ferromagnetic particles. In MR clutches the viscosity of the ferromagnetic fluid provides a means of tuning the torque. Thus, the damping of clutches can be adjusted by tuning the coil current. The integration of the ferromagnetic parts, the magnetic fluid, and a coil in the clutch structure results in relatively heavy-weight not desirable for several practical applications, especially in the context of wearable robotics such as exoskeletons [20]. In addition, the generation of the magnetic field leads to high power consumption, which again is a challenge for wearable and mobile applications [21]-[23]. In an effort to address these issues by eliminating heavy ferromagnetic parts and the electric coil, electro-rheological (ER) clutches have been considered as an alternative [24]-[26]. However, the low viscosity of ER fluids significantly reduces the performance of ER clutches in comparison to MR clutches.

The electrostatic force has been harnessed to generate Electroadhesion (EA), mostly for object handling and robotic locomotion applications [27], [28]. In contrast to the magnetic field, the required energy to generate an electric field is very small, and there is no need for heavy parts and fluid (which may have a leakage problem). The electrostatic force, therefore, shows high potential to be exploited for producing adjustable smart clutches, in a low-space, lightweight, and energy-efficient manner. In this regard, the EA force has been used as a binary joint locking mechanism for a robotic hand [29]. Diller et al. utilized EA force in a translational locking mechanism for a passive energy-storing ankle exoskeleton [8]. EA clutches have been used in haptic feedback-based wearable devices in [30], [31]. Zhang et al. used EA clutch in a locking mechanism for a 2.5D tactile display [32].

The EA force has not been limited to the above-mentioned applications and has also been used in applications such as active connection mechanisms, stiffness tuning in composite structures, and controllable perching mechanisms [33]. Despite the functionality in many applications, shear EA clutches have only been used to create binary static friction in locking mechanisms in an on/off mode. The lack of implementation of a device with adjustable EA shear force is perhaps caused by the degradation of the EA force with time due to residual charges, resulting in time-dependent dynamics of the EA force, which makes such an implementation complex [29], [31], [32], [34], [35]. To the best of our knowledge, all existing EA clutches (except which was designed for locking a limited revolute joint), have been implemented with linear motion, which creates restrictions for most applications that require infinite rotations i.e., a walker. While linear EA clutches have been used in ankle exoskeletons [8], a rotary EA clutch can simplify the mechanical design of the device and minimize space.

II. CONCEPTS. An electroadhesive force is an electrostatic force between two charged particles, whether they are conductors or insulators. However, the mechanism for EA force generation in conductors is different from that in insulators. The EA force in conductors is mainly generated from the attraction of charges on the electrodes. The shear stress on the interface of the electrodes is governed by Columb's law as shown below:

$${σ}_{sh} = \frac{{ϵ}_{r} {ϵ}_{0} {V}^{2} {C}_{f}}{2 {d}^{2}} \qquad ( 1 )$$

where ϵr is the relative permittivity of the insulator, ϵ0 is the permittivity of vacuum, V is the applied voltage across the electrodes, Cf is the friction coefficient, and d is the distance between the electrodes.

Electroadhesive force in insulators results from the polarization of the dielectric, which cannot be formulated in detail without knowledge of the molecular structure of the dielectric. The electric field polarizes the insulator and results in an adhesion force that can be formulated as

$${σ}_{sh} = \frac{{PEC}_{f}}{A} \qquad ( 2 )$$

where E is the electric field, A is the overlap area, and P is the polarization which can be simply formulated as follow for materials such as barium titanate,

$$P = {P}_{o} + {P}_{s} \qquad ( 3 )$$

where Po is the orientational polarization, and Ps is the space charge polarization due to hopping and interfacial polarizations [37]. The latter polarization has sluggish dynamics with a relatively large time constant.

Based on the mechanical structure of the system, one or both of the above-mentioned mechanisms may be involved in the electroadhesion shear stress.

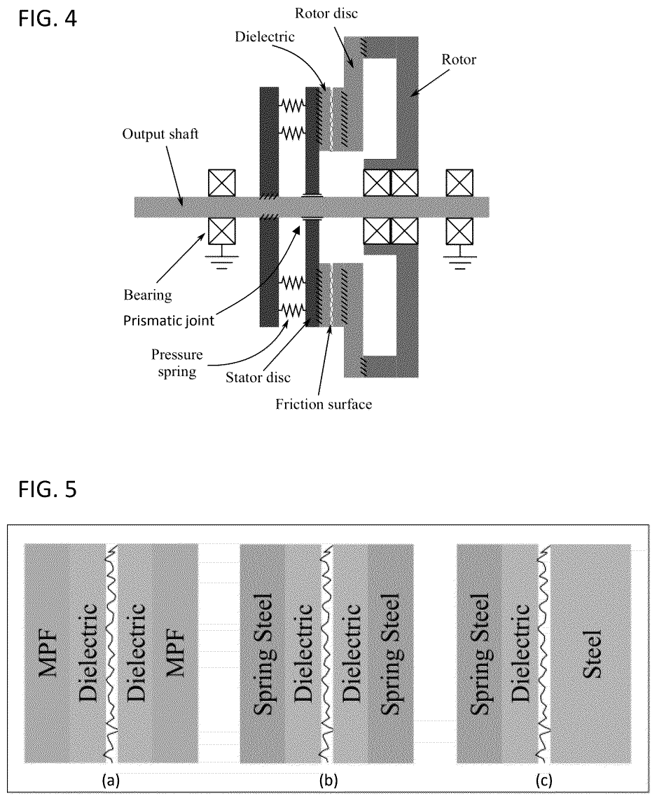

III. CLUTCH DESIGN AND FABRICATION. A. Mechanical design. The core of the proposed rotary EA clutch consists of a rotor disc (outer disc) and a stator disc (inner disc) sliding against each other. Each disc acts as an electrode; thus, the clutch can be analogously considered a capacitor. The applied voltage across the clutch discs generates an electric field that develops an attraction force between both conductors and insulators, as explained in Section II. This creates a ring-like friction area that transfers the torque between the discs. The friction surfaces of the discs are covered with Dupont 8153 dielectric (Luxprint, Dupont Microcircuit Materials, NC, USA), which is a barium titanate-based dielectric to prevent electric discharge. Ideally, a small gap should be maintained between the discs to avoid undesirable friction and wear on the discs. At the same time, to maximize the EA forces and the response time of the clutch, a zero-gap should be kept between the discs. Addressing these two competing design requirements without adding other components and increasing the complexity and cost of the overall design is not possible. To this effect and for the purpose of this initial study, pressure springs were integrated into the design to continuously push the stator disc against the rotor disc with an infinitesimal air gap between the discs. The springs keep the discs ready to engage and reduce the activation time of the clutch. A schematic of the clutch can be seen in FIG. 4.

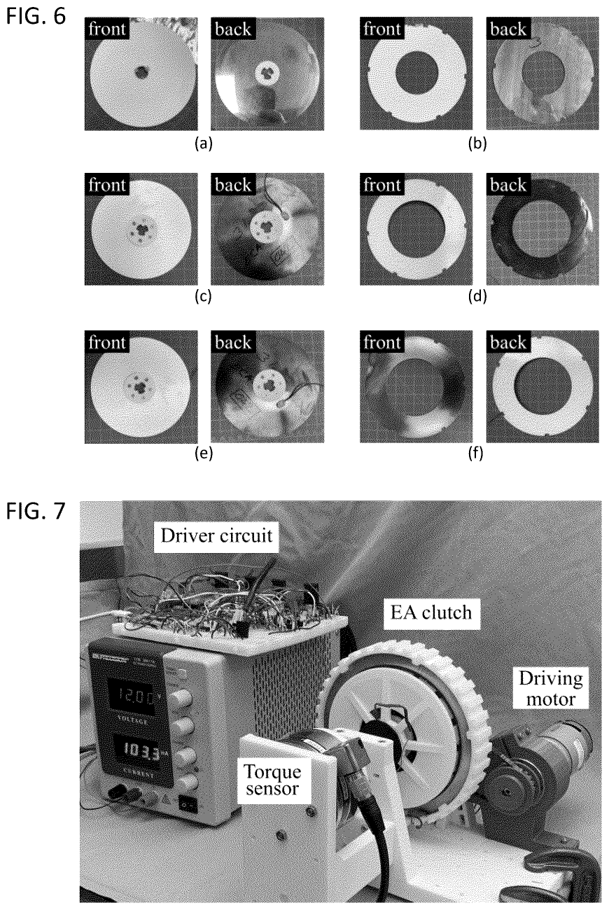

We considered a number of different configurations of the discs, including different substrate materials and different friction surfaces in our initial feasibility studies and further investigated multiple configurations experientially to arrive at the desired results. The first configuration was based on the method mentioned in which had two major issues: high electric resistance and rough sliding friction. The second configuration was a trial to address the high electrical resistance issue of the first configuration. The third configuration was a trial to address the rough friction issue. These three configurations are compared in detail in Section IV. FIG. 5 shows a schematic of the disc configurations. The details of the disc configurations are as follow:
1) A sheet of Metalized Polyester Film (MPF) with 0.127 mm thickness (McMaster Carr, ON, Canada) was used as the substrate. The dielectric was applied to the metalized side of MPF using a 25 μm wire-wound wet film applicator (GARDCO, FL, USA). The sheet was then cured for 2 hours in 130°, rested for 5 hours, and again cured for 2 hours in 130°. This procedure was repeated to reach the desired dielectric thickness. After curing the dielectric, the sheet was cut to shape with a laser cutting machine (FIG. 6(a) and FIG. 6(b) show the discs.). A small area of the dielectric was cleared with Acetone-99.5% (McMaster Carr, ON, Canada), and a wire was connected to the conductor side of the disc with 8331-Silver Conductive Epoxy (MG Chemicals, BC, Canada).
2) 1095 Spring Steel with a thickness of 0.102 mm (McMaster Carr, ON, Canada) was used as the substrate. The dielectric was applied with the same procedure as described before, and the sheet was sandwiched with thick steel plates and cut to shape with electric discharge machining. A wire was connected to the bare side of the sheets with conductive epoxy. FIG. 6(c) and FIG. 6(d) show the disc pair for the second configuration.
3) A stator disc was made similar to the one built in the second pair but with a thicker dielectric layer. The same rotor disc of configuration #2 was used for the rotor. However, in this configuration, the steel side of the rotor disc was used for the friction interface. This surface was sanded with 220 grit sandpaper (McMaster Carr, ON, Canada). FIG. 6(e) and FIG. 6(f) show the third configuration.

The inner diameter of the rotor disc and the outer diameter of the stator disc is 8 cm and 12 cm, respectively. This creates a ring shape friction area with an inner diameter of 8 cm and an outer diameter of 12 cm. Assuming a constant shear stress over the friction ring, the maximum achievable output torque will be,

$$T = \frac{2 π ( {r}_{3}^{2} - {r}_{1}^{3} ) {σ}_{sh}}{3} \qquad ( 4 )$$

where r1 and r2 are the inner and outer radii of the friction ring, respectively, and σₛₕ is the shear stress due to electroadhesion.

B. Driver circuit design. In order to activate the clutch, a high-voltage potential is needed across the clutch discs. In our setup, a high voltage PHV 12 DC-DC transformer (Bellnix Co., Saitama, Japan) was utilized to feed the circuit with the required voltage. An R2R digital-to-analog converter was used to adjust the reference voltage of the transformer. In order to change the polarity of the activation of the clutch, a high-voltage IGBT (Infineon Technologies, Neubiberg, Germany) H-bridge was used. This allowed activation of the clutch under an Alternating Current (AC) waveform as well as Direct Current (DC). For safety reasons, the high-voltage part of the driver circuit was isolated from the logic part using optocouplers and isolated DC-DC converters. An Arduino microcontroller board was utilized to interface the driver with a computer.

C. Experimental setup. An experimental setup was fabricated to validate the performance of each pair of discs. Except for the clutch discs, the shaft, and the standard parts, other parts of the setup and EA clutch were fabricated with 3D printing. The diameter of the fabricated EA clutch used in the setup was 15 cm, the thickness of a pair of clutch discs was 0.36 mm, the thickness of the complete clutch unit, including the pulley and slipring, was 73 mm, and the length of the output shaft of the clutch was 166 mm. The mass of a pair of clutch discs for the configuration #2 and #3 was 20 g and for the configuration #1 was less. The mass of the complete EA clutch (excluding the base frame, motor, and torque sensor) was around 420 g. It should be noted that the housing and other main components of the proposed EA clutch were not designed to be weight-efficient. Since the setup was developed for validation purposes, it was slightly over-designed with larger space between the components to allow future expansion and modification of the setup. The point to highlight is the lightness of the core components of the clutch i.e., the clutch disc. This allows to integrate a number of clutch discs in the same cover for a much higher torque-to-weight ratio of the EA clutch. The overall weight of the EA clutch can be further reduced by the optimal design of the components.

The clutch was driven using a DC gear motor (Micro-Drives M4870U with 1:294 gear ratio) controlled by a Maxon EPOS2 under speed control mode with a constant speed. The output of the clutch was connected to a torque sensor (ATI Industrial Automation, NC, USA). The stator disc was directly connected to the driver circuit, and the rotor disc was connected to the driver circuit through a slip-ring to allow free rotation of the disc. FIG. 7 shows the fabricated experimental setup.

Data acquisition and control of the clutch were made using QuaRC real-time control software (Quanser, ON, Canada) in the MATLAB Simulink environment because of versatility and easy-to-use connection establishment with the experimental setup. The frequency of data acquisition was set to 500 Hz for validating the clutch performance under AC activation signals and for validating pHRI.

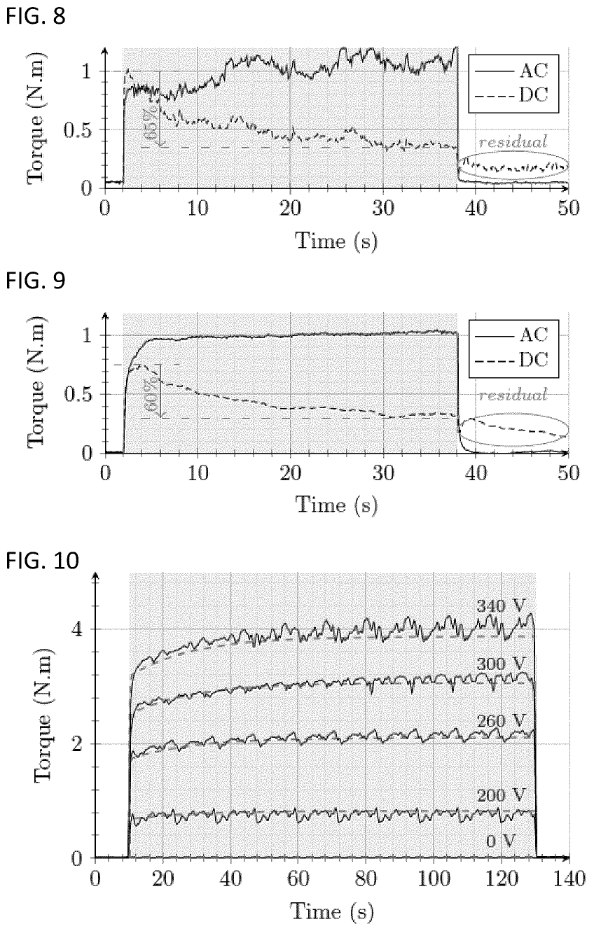

IV. CLUTCH DISCS SELECTION. The performance of the clutch was evaluated with each configuration explained above. Configuration #1 was tested in the test-setup with a constant 400 volts DC activation. The dashed line graph in FIG. 8 shows the results for configuration #1. As seen in the figure, the torque degrades up to almost 65% with the passage of time. In addition, the residual torque can be seen after the deactivation of the clutch. The torque degradation and residual torque result from the charge buildup in the dielectric due to the constant electric field [39]. In this work, we addressed the charge build-up issue by activating the clutch with an AC waveform [34]. Activating an EA clutch with an AC waveform required a different disc configuration since the conductor film of MPF was too thin, resulting in significant resistance. This resistance prevented the required current flow due to charge-discharge cycles needed under AC activation. The higher resistance and the heat build-up can damage the conductor area close to the wire-to-disc connection on MPF.

In order to solve the above-mentioned problem, configuration #2, which was made of a thicker layer of conductor, was fabricated. Configuration #2 was evaluated using an AC square waveform activation with an amplitude of 400 V and frequency of 50 Hz. The black graph in FIG. 8 shows the output torque of configuration #2 under AC activation. It can be seen that the issue of torque degradation and residual torque after deactivation are substantially improved. However, the clutch torque fluctuates significantly (Torque=1±0.11 N·m). This phenomenon is because of the rough friction that results from the same materials sliding against each other (dielectric against dielectric). Atomic and molecular bonds may form between the surfaces of the dielectric, which results in a high coefficient of friction affecting the smoothness of the torque transfer and, therefore, higher shear force. This can be good for locking mechanisms but not for a tunable system such as the one proposed here.

In order to address torque fluctuations, configuration #3 was proposed, in which dielectric were placed against steel (not another layer of dielectric). FIG. 9 shows the results for both AC and DC activations in configuration #3. As seen, the torque fluctuation is almost 6 times less than that in configuration #2 (Torque=1±0.02 N·m for configuration #3 vs. Torque=1±0.11 N·m for configuration #2). It is clear that configuration #3 with an AC activation offers the best performance with no obvious issue. Configuration #3 was selected for further investigation and further development of the experimental setup.

V. PERFORMANCE EVALUATION AND MODELING. In this section, the proposed configuration #3 is evaluated through a series of tests using both AC and DC activations. A. Experiment condition. In these tests, the rotor of the clutch was rotated with a constant velocity of 5 RPM in each test and the clutch was activated for a period. The maximum torque of the motor was set to be more than the maximum clutch torque to allow clutch discs to continuously slide against each other when the clutch was active. After each DC activation test, the clutch was activated with 260 volts AC waveform for three minutes to depolarize the dielectric before the next test. All experiments were carried out at room temperature (20° C.25° C.) and humidity (30%-50%). The procedure was repeated for different activation voltages, and the output torque of the clutch was recorded.

B. AC activation model. FIG. 10 shows the results for 300 Hz AC activation. The amplitude of the square activation signal was in the range of 0 V to 340 V. The results support the desired functionality for the proposed design as the torque remains almost constant during the activation period without degradation. The fast transition dynamics for the major part of the torque, along with slow transition dynamics for the minor part of the torque, can be seen at the beginning of the diagram.

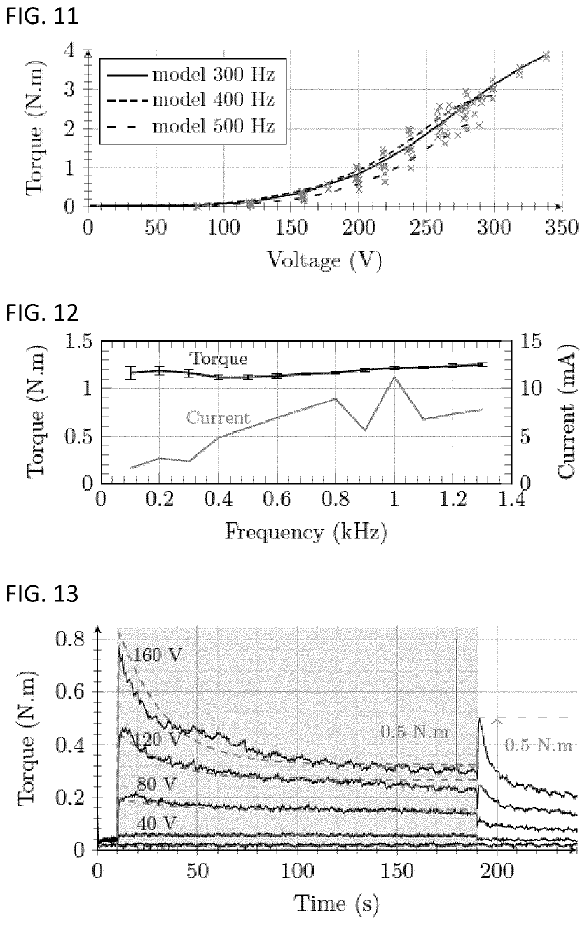

As observed in FIG. 10, the transmission torque of the EA clutch increases with the increase of the voltage. This can be seen more clearly in FIG. 11 which shows the average torque versus the activation voltage for the AC activation signal for different frequencies of 300 Hz, 400 Hz, and 500 Hz. To study potential uncertainties and assess the effect of model, we recorded the results on three different days to account for any changes in the friction properties due to temperature and humidity changes. As seen in FIG. 11, some saturation can be seen for activation voltages above 250 V roughly, which was expected based on the literature on electroadhesion saturation [39], [40]. The activation voltage for which torque saturation occurs reduces with the increase of the frequency of the activation signal. The occurrence of torque saturation at lower activation voltage prevents achieving higher torque when the frequency is high. The torque saturation is caused by the dielectric leak, which increases exponentially in high voltages, and possibly because of the accumulation of residual charges, which prevent higher electric charge on the discs. As the frequency of the signal increases, the resistance of the dielectric and the reactance of the clutch (which acts similar to a capacitor) reduces, resulting in a higher current leak through the dielectric [33]. The lower is the frequency, the higher is the maximum torque that leads to dielectric breakdown.

On the other hand, higher frequency provides a smoother output torque. Therefore, there is a trade-off between the maximum achievable torque and the smoothness of the torque. As seen in the same figure, the maximum torque achieved using one pair of clutch discs and an AC activation signal with a frequency of 300 Hz is 3.9 N·m. This amount of torque is sufficient for most upper-limb human robot interaction applications as will be shown in Section VI. We also noted that the frequency of the activation signal affected the sound noise generated by the clutch.

Using the general model of shear stress presented in (1), the following model is proposed to explain and predict the behavior of the designed EA clutch.

$$\overline{{σ}_{sh}^{AC}} ( V ) = {C}_{f} ( {σ}_{0} + \frac{K {ϵ}_{r} {ϵ}_{0} {V}_{eff}^{{n}_{1}} ( V )}{{d}^{2}} ) \qquad ( 5 )$$

where Cf is the friction coefficient, σ0=0.02 N·m-2 is the permanent pressure due to pressure springs, K is a correction factor, ϵr=35 is the relative permittivity of the dielectric, ϵ0 is the permittivity of vacuum, n1 is a coefficient defining the intensity of the effect of voltage on the shear stress, d=80 μm is the dielectric thickness, and Veff is the effective voltage that is calculated as follows,

$${V}_{eff} ( V ) = V - ln ( 1 + {e}^{δ ( V - c )} ) \qquad ( 6 )$$

in that V, c, δ are input voltage, saturation voltage, and sharpness factor of the saturation function, respectively.

The hyperparameters of the model in (5) and (6) depend on the frequency of the activation signal and the fabrication process. Therefore, these parameters should be calculated through system identification using the torque-voltage experimental results (see FIG. 11). To this effect, individual models were fitted to the data for each activation frequency using the least-squares method. The torques of the EA clutch predicted using the above-mentioned models as a function of the activation voltage are shown in FIG. 11 using solid lines. The values of the hyperparameters and estimation errors of the models are shown in Table 1

TABLE 1
Identified parameters of the models.

| freq (Hz) | error (N · m) | K | n | c (V) | δ |
|---|---|---|---|---|---|
| 300 | 1.79 × 10⁻¹ | 1.01 × 10⁻⁴ | 3.89 | 306.51 | 38.89 |
| 400 | 1.40 × 10⁻¹ | 2.45 × 10⁻⁴ | 3.74 | 279.49 | 25.83 |
| 500 | 1.27 × 10⁻¹ | 7.3 × 10⁻⁵ | 3.88 | 281.92 | 6.67 |

Also, as seen, the predicted torque by the model is related to the voltage by a exponent of 3.8, which does not comply theoretical model presented in (1) that is related to the square of the voltage. This is due to the fact that the actual effect of voltage on the transmission torque is more than what can be captured using (1). This observation is somewhat intuitive because in (1), only the effect of the shear stress due to the attraction force between the conductors is included. However, in practice, the attraction force between the clutch discs is due to the attraction of the conductors as well as the attraction between the dielectric particles on the stator disc and the rotor disc (as mentioned in (2)), which are both related to the activation voltage. The latter attraction force is difficult to be modeled without the molecular knowledge of the dielectric. In addition, the relation of the friction force to the pressure may also be nonlinear, leading to a nonlinear dependency of the torque to the applied voltage.

Another important observation based on the results in FIG. 10 is the finite rise time for the torque. This time-dependent behavior is not due to the sluggish dielectric polarization because the polarization part with slow dynamics was eliminated under a high-frequency AC activation regime [34]. Therefore, the time-dependent behavior is believed to be due to mechanical characteristics of the system, including dielectric surface texture and friction dynamics. Because these effects cannot be investigated without the knowledge of dielectric surface texture, two independent exponential activation functions with independent time constants were added to the time-independent torque model (6) to model the torque dynamics that immediately appear after the activation voltage is applied, as shown below,

$${σ}_{sh}^{AC} ( t , V ) = \overline{{σ}_{sh}^{AC}} ( V ) ( α ( 1 - {e}^{- t / {τ}_{1}} ) + ( 1 - α ) ( 1 - {e}^{- t / {τ}_{2}} ) \qquad ( 7 )$$

Where τ₁ and τ₂ are time constants of the faster and slower activation functions, respectively, and α is the weighting factor that defines the portion of the output torque that reacts with time constant τ₁. These values were determined to be 0.14 s, 18.70 s, and 0.82, respectively, through system identification using (7) to the experimental torque-time data. According to obtained dynamic model, 82% of the torque reacts to the input signal with a time constant of 0.14 s, and the remaining 18% of the torque reacts with a slower dynamic with a time constant of 18.7 s. The results from this model for various activation voltages are shown in FIG. 10 using dashed lines. It can be seen that the proposed dynamic model has a high agreement with the experimental recordings. The results also verify that the two activation functions with short and large time constants affect the dynamics of the system.

C. Frequency Effect. The output torque of the EA clutch and associated input current were obtained for an activation voltage with various frequencies and a constant amplitude (180 AC volts). FIG. 12 shows the effect of the activation frequency on the output torque and the input current. The output torque diagram is the average of four repeated tests, and the error bars are standard deviations. Results are for frequencies ranging from 100 Hz to 1300 Hz. It can be seen that the output torque reduces with the increase of the frequency so long as the frequency remains below 500 Hz. However, when the frequency is above 500 Hz, the torque increases with a small slope with the frequency increase. There are uncertainties (mostly due to friction and the changes in the surface finish with the age of the clutch) that have effects on the output torque, as can be seen in FIG. 11. However, there is no solid explanation for the torque increase with the frequency increase when the frequency is above 500 Hz. The most significant effect of the activation frequency is on the saturation voltage, which drops as the frequency increases (see FIG. 11). Also, it can be seen that the standard deviations are larger at lower frequencies, which shows higher torque fluctuations at lower frequencies. The fluctuations remain almost constant over 500 Hz. The lower fluctuations and the lower sound noise were among the reasons that a frequency of 500 Hz was selected for the subsequent tests.

In addition, it can be seen that although the torque remains constant with the increase of the frequency, the required current increases in a non-monotonic manner. The increase of the current with the increase of the frequency can be explained as follows: First, in each period of the activation signal, the EA clutch would charge, discharge, and charge again with opposite polarity, and discharge again. Assuming a small unit of energy is exchanged in each cycle, with the increase of the frequency, the number of charge-discharge cycles increases; resulting in increased heat dissipation in a unit of time [31]. Second, the resistance of the dielectric reduces with the increase of frequency which leads to a higher charge leak through the dielectric. The same relation between frequency and power consumption is also reported in for CMOS integrated circuits.

D. DC activation model. Although in this paper we proposed the use of AC voltage to address the torque performance of the EA clutch, it is useful to study and understand the behaviour of the EA clutch under DC activations as well.

To this end, FIG. 13 shows the results for different DC activation voltages. As expected, the EA clutch torque increases with the increase of the activation voltage, which is because of the increase of the electric field with voltage. In addition, it can be seen that the maximum torque of the EA clutch is reached at the beginning of the activation cycle. After that, the torque starts to degrade exponentially until it reaches a saturated value [34].

As explained in Section II, the attraction force between the clutch discs results from the charge accumulated on the conductors as well as the polarization of the dielectric that is placed in an electric field. The dielectric polarization in materials, such as barium titanate, is mostly because of the orientational polarization (which has a short time constant of less than 10 μs) and space charge polarization (which has a larger time constant up to hundreds of seconds) [37]. Although, in orientational polarization, only the direction of the dipoles, which does not affect the primary electric field, changes, in space charge polarization, electrons migrate to the surface of the dielectric and may get stuck on the surface. This results in charge build-up on the surface of the dielectric and develops an electric field that counteracts the primary electric field, leading to a resultant electric field that is formulated as follows [37],

$$\vec{E} ( t ) = \vec{{E}_{p}} + \vec{{E}_{r}} ( t ) \qquad ( 8 )$$

where E^{→}p is the primary electric field due to the applied voltage and E^{→}r is the electric field due to charge build-up inside the dielectric because of the dielectric polarization.

In addition to the torque degradation issue, there exists residual torque after the deactivation of the clutch. In FIG. 13, the residual torque can be seen after t=190 s. With the removal of the primary electric field, the resulting electric field, which used to be the summation of E^{→}p and E^{→}r (t) will change to only E^{→}r(t). This activates the EA clutch with a reverse polarity which decays with the depolarization time constant of the dielectric. The magnitude of the resultant electric field can be formulated as follows,

$$‖ E ( t ) ‖ = \{ \begin{matrix}‖ {E}_{p} ‖ - ‖ {E}_{r} ( t ) ‖ & activated \\ ‖ {E}_{r} ( t ) ‖ & deactivated\end{matrix} \qquad ( 9 )$$

Following the removal of the primary electric field, the electric field created by the residual charges keeps the clutch engaged. The initial value of the torque after the deactivation of the clutch is equal to the amount of degradation of the torque at the end of the active cycle (see FIG. 13), verifying the dynamics explained in (9).

In order to model the dynamics of the clutch in DC activation, an exponential degradation function is multiplied by the AC model given in (7) as shown below,

$${σ}_{sh}^{DC} ( t , V ) = {σ}_{sh}^{AC} ( t , V ) ( 1 - ( 1 - {e}^{- t / {τ}_{d}} ) {C}_{s} {V}^{{n}_{2}} ) \qquad ( 10 )$$

where td is the time constant of the degradation function. The term CsV n2 is added to adjust the effect of the voltage on the saturation of the settled torque. The unknown parameters are calculated by fitting the proposed model to the experimental data using the least-squares method. As such, τd, n2, Cs, were determined to be 20.9 s, 1.17, and 0.0017, respectively, which says that the torque degrades by 63% in the first 20 seconds of activation. Therefore, it can be said that the output torque of the EA clutch is subjected to significant degradation under DC activation. The results from the proposed model are shown by the dashed lines in FIG. 13.

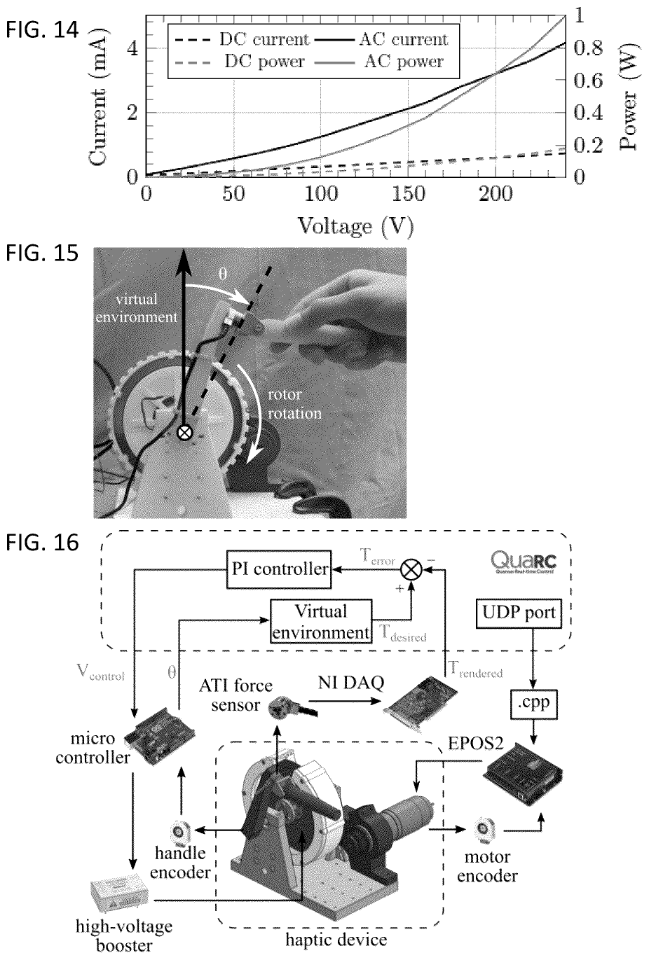

E. Power consumption. FIG. 14 shows the input current and power consumption of the EA clutch (including the driver circuit) under 500 Hz AC and DC activations. As expected, the current and power consumption increase with the increase of the voltage. However, the power consumption in 500 Hz AC activation is almost five times more than the power consumption in DC activation. The higher power consumption in AC activation is because of the charge-discharge cycles and higher charge leak through dielectric [31]. The power consumption of the proposed clutch at 2 N·m torque (240 voltage AC activation) is 1 W, which is six times less than an off-the-shelf MP clutch with equivalent output torque (see at 2 N·m output torque).

VI. PHYSICAL HUMAN-ROBOT INTERACTION EXPERIMENT. In this section, experiments were performed to validate the performance of the proposed EA clutch in pHRI.

A. Experimental setup. The experimental setup shown in FIG. 7 was modified into a one-DoF haptic device, as shown in FIG. 15. An 11 cm arm was connected to the output shaft of the clutch. A handle was connected to the end of the arm with a revolute joint. An ATI nano 17 force/torque sensor was mounted between the handle and the arm to measure the interaction forces. An incremental encoder (CUI AMT10 with 2048 counts per revolution) was used to measure the joint angle of the haptic arm.

A simple impedance control based on a proportional-integral controller was implemented to render a virtual environment using a virtual rotational spring around the output shaft of the clutch with the stiffness of K. The virtual environment covered the space where θϵ[−π/2,0]. The virtual environment applies different values of resistive torque depending on its stiffness and the angle of the haptic arm. For data acquisition and control, we used QuaRC real-time control software (Quanser, ON, Canada) in the MATLAB Simulink environment with a sampling frequency of 500 Hz. FIG. 16 shows the schematic of the system.

Three different stiffness values to resemble a soft (K=1 N·m/rad), medium (K=2 N·m/rad), and hard (K=4 N·m/rad) environment were implemented in the experiments. The user interacted with the environment by moving the haptic handle in a reciprocating fashion during the experiments. In the first experiment, the controller parameters were manually tuned to

KP=200 and KI=10000, and the rotor of the clutch was rotated with a constant velocity of 15 RPM so that the haptic device could apply resistive and assistive forces in the positive direction. In the second experiment, the input velocity of the clutch was set to zero, and the controller parameters were manually tuned to KP=800 and KI=0. Because of the zero input velocity, the haptic device could only apply a resistive force. Thus, an automatic switch was implemented in the code to release the clutch when the handle was getting out of the environment to avoid resistive force on exit.

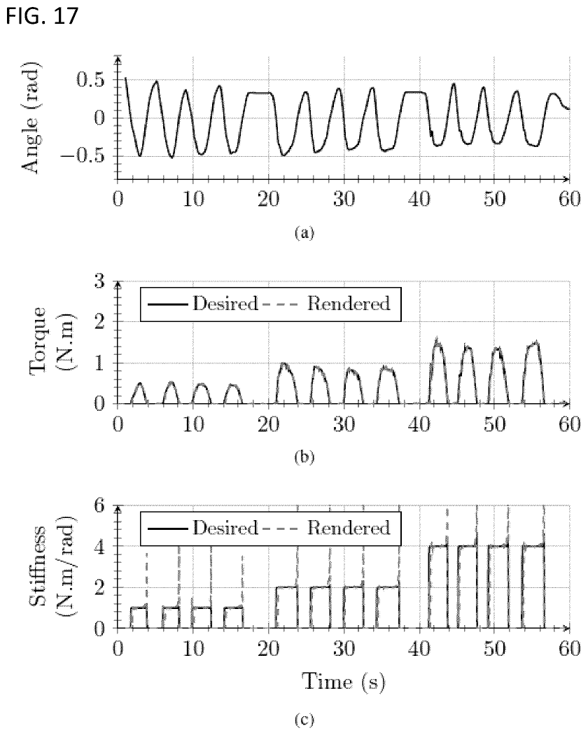

B. Results and discussion. Results of the first pHRI experiment can be seen in FIG. 17. FIG. 17(a) shows the angle of the haptic handle. As seen, the rendered torque of the haptic device perfectly tracks the desired environmental torque in both forward and backward motions. The clutch is able to track the desired torque in backward (positive) direction as long as the velocity of the operator's hand is lower than the rotation velocity of the clutch rotor [18]. The same performance can be seen in FIG. 17(c), where the rendered stiffness tracks the desired stiffness. Spikes in the rendered stiffness are due to the short time delay (in the order of 50 milliseconds) of the control signal which is related to the time lag of the high-voltage booster and the time lag due to the integral part of the controller used to activate the clutch.

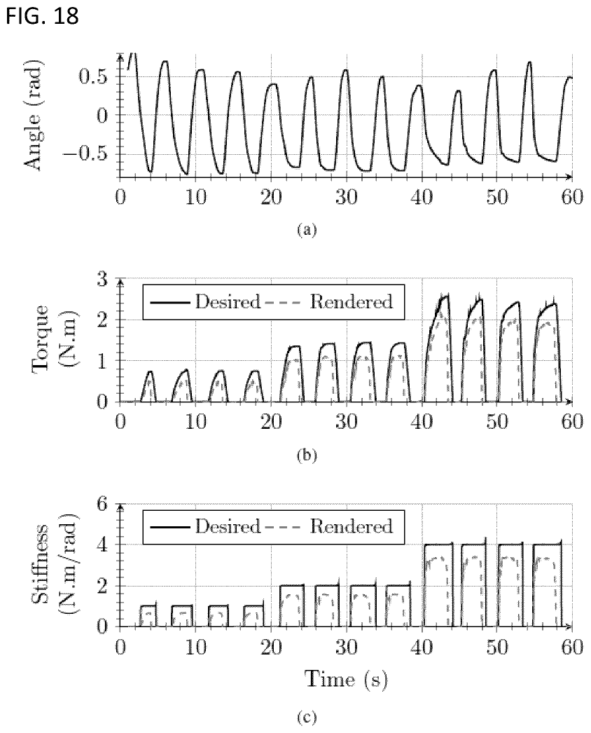

The second set of experimental results are shown in FIG. 18. FIG. 18(b) shows the desired and rendered torque due to the stiffness of the virtual environment. As ward seen, the rendered resistive torque tracks the desired trajectory in forward (negative) direction of the handle, which pushes the handle into the environment. A slight deviation from the desired torque is due to the simplicity of the proportional controller used in this experiment. The integral term of the controller was eliminated to avoid the accumulation of the control action due to steady-state errors. For the positive velocity of the handle, the rendered force drops to zero because of the automatic release switch integrated into the code. The same behaviour can be seen in the rendered stiffness shown in FIG. 18(c).

The proposed rotary EA clutch offers a much higher torque-to-weight ratio and torque-to-power ratio than common adjustable clutches. Unlike MR clutches that need a heavy coil, permanent magnet, and MR fluid to operate [21], an EA clutch only needs a pair of clutch discs covered with a thin layer of dielectric. Our study shows that a pair of discs that weigh around 20 grams can transfer up to 3.9 N·m of torque. The results are important as they inform the feasibility of increasing the number of clutch discs in parallel without a significant increase in the total weight of the clutch. Up to 20 N·m of torque can be achieved for a clutch with around 500 grams. This range of torque is suitable for direct implementation in mobile systems interacting with humans such as robotic walkers [13].

In terms of the design complexity, an EA clutch is much simpler to design than ER and MR clutches since an EA clutch does not require sealing to keep the operational fluid inside the clutch [21], [25]. However, as mentioned in Section III, the process of applying the dielectric on the clutch discs is time-consuming due to the need for multiple repetitions and high fabrication accuracy. Moreover, the output torque of the EA clutch is more prone to variations due to the variations of the dry friction compared to ER and MR clutches that use viscous friction.

VII. CONCLUSIONS. A novel rotary electroadhesive clutch was designed and fabricated for human-robot applications. The proposed method enabled torque controllability by adjusting the activating voltage. Three different materials were investigated for the clutch discs, and the performance of the clutch was validated through extensive experiments including physical human-robot interaction. Two main issues of torque degradation with time and residual torque after deactivation were addressed by activating the clutch with alternating current. In addition, a new computational model was proposed to estimate the dynamics of the clutch torque for both direct and alternating current activations. Such models are essential for dynamic closed-loop control. The proposed clutch demonstrated a torque power consumption ratio of six times more than a commercial magnetic particle clutch. The proposed clutch showed great potential for application in safe passive actuators such as those required for lightweight and low-power consumption robotic systems in the future.

### VIII. Reference List for Experimental Example 1

[1] A. Zacharaki, I. Kostavelis, A. Gasteratos, and I. Dokas, “Safety bounds in human robot interaction: A survey,” Safety science, vol. 127, p. 104667, 2020.
[2] S. F. Atashzar, M. Shahbazi, M. Tavakoli, and R. V. Patel, “A passivitybased approach for stable patient-robot interaction in haptics-enabled rehabilitation systems: modulated time-domain passivity control,” IEEE Transactions on Control Systems Technology, vol. 25, no. 3, pp. 991-1006, 2016.
[3] N. Feizi, S. Thudi, R. V. Patel, and S. F. Atashzar, “Time-domain passivity-based controller with an optimal two-channel lawrence telerobotic architecture,” in 2021 IEEE International Conference on Robotics and Automation (ICRA). IEEE, 2021, pp. 3865-3871.
[4] N. Feizi, R. V. Patel, M. R. Kermani, and S. F. Atashzar, “Adaptive wave reconstruction through regulated-bmflc for transparency-enhanced telerobotics over delayed networks,” IEEE Transactions on Robotics, 2022.
[5] A. Aziminejad, M. Tavakoli, R. V. Patel, and M. Moallem, “Transparent time-delayed bilateral teleoperation using wave variables,” IEEE Transactions on control systems technology, vol. 16, no. 3, pp. 548-555, 2008.
[6] N. Lauzier and C. Gosselin, “Series clutch actuators for safe physical human-robot interaction,” in 2011 IEEE International Conference on Robotics and Automation. IEEE, 2011, pp. 5401-5406.
[7] C. Khazoom, C. Veronneau, J.-P. L. Bigu′ e, J. Grenier, A. Girard, and′ J.-S. Plante, “Design and control of a multifunctional ankle exoskeleton powered by magnetorheological actuators to assist walking, jumping, and landing,” IEEE Robotics and Automation Letters, vol. 4, no. 3, pp. 3083-3090, 2019.
[8] S. Diller, C. Majidi, and S. H. Collins, “A lightweight, low-power electroadhesive clutch and spring for exoskeleton actuation,” in 2016 IEEE International Conference on Robotics and Automation (ICRA). IEEE, 2016, pp. 682-689.
[9] L. Roveda, S. Haghshenas, M. Caimmi, N. Pedrocchi, and L. Molinari Tosatti, “Assisting operators in heavy industrial tasks: On the design of an optimized cooperative impedance fuzzy-controller with embedded safety rules,” Frontiers in Robotics and AI, vol. 6, p. 75, 2019.
[10] A. S. Shafer and M. R. Kermani, “On the feasibility and suitability of mr fluid clutches in human-friendly manipulators,” IEEE/ASME Transactions on Mechatronics, vol. 16, no. 6, pp. 1073-1082, 2010.
[11] V. Mehrabi, S. F. Atashzar, H. A. Talebi, and R. V. Patel, “Design and implementation of a two-dof robotic system with an adjustable force limiting mechanism for ankle rehabilitation,” in 2019 International Conference on Robotics and Automation (ICRA). IEEE, 2019, pp. 577-583.
[12] E. J. Rousc, L. M. Mooncy, and H. M. Herr, “Clutchable scrics-elastic actuator: Implications for prosthetic knee design,” The International Journal of Robotics Research, vol. 33, no. 13, pp. 1611-1625, 2014.
[13] Y. Hirata, A. Muraki, and K. Kosuge, “Motion control of intelligent passive-type walker for fall-prevention function based on estimation of user state,” in Proceedings 2006 IEEE International Conference on Robotics and Automation, 2006. ICRA 2006. IEEE, 2006, pp. 3498-3503.
[14] P. Dills, N. Colonnese, P. Agarwal, and M. Zinn, “A hybrid activepassive actuation and control approach for kinesthetic handheld haptics,” in 2020 IEEE Haptics Symposium (HAPTICS). IEEE, 2020, pp. 690-697.
[15] N. Najmaei, A. Asadian, M. R. Kermani, and R. V. Patel, “Design and performance evaluation of a prototype mrf-based haptic interface for medical applications,” IEEE/ASME Transactions on Mechatronics, vol. 21, no. 1, pp. 110-121, 2015.
[16] N. Najmaei, P. Yadmellat, M. R. Kermani, and R. V. Patel, “Application of magneto-rheological fluid based clutches for improved performance in haptic interfaces,” in 2014 IEEE International Conference on Robotics and Automation (ICRA). IEEE, 2014, pp. 832-837.
[17] A. S. Shafer and M. R. Kermani, “Design and validation of a magnetorheological clutch for practical control applications in human-friendly manipulation,” in 2011 IEEE International Conference on Robotics and Automation. IEEE, 2011, pp. 4266-4271.
[18] S. Pisetskiy and M. Kermani, “High-performance magneto-rheological clutches for direct-drive actuation: Design and development,” Journal of Intelligent Material Systems and Structures, p. 1045389X211006902, 2021.
[19] PLACID industries, “Magnetic Particle Brakes,” 2021. [Online]. Available: https://placidindustries.com/products/brakes/magneticparticle-brakes/
[20] L. Roveda, L. Savani, S. Arlati, T. Dinon, G. Legnani, and L. M. Tosatti, “Design methodology of an active back-support exoskeleton with adaptable backbone-based kinematics,” International Journal of Industrial Ergonomics, vol. 79, p. 102991, 2020.
[21] M. Moghani and M. R. Kermani, “Design and development of a hybrid magneto-rheological clutch for safe robotic applications,” in 2016 IEEE International Conference on Robotics and Automation (ICRA). IEEE, 2016, pp. 3083-3088.
[22] M. Moghani and M. R. Kermani, “A lightweight magnetorheological actuator using hybrid magnetization,” IEEE/ASME Transactions on Mechatronics, vol. 25, no. 1, pp. 76-83, 2019.
[23] P. S. Wellborn, J. E. Mitchell, N. J. Pieper, and R. J. Webster III, “Design and analysis of a small-scale magnetorheological brake,” IEEE/ASME Transactions on Mechatronics, pp. 1-11, 2021.
[24] J. Nikitczuk, B. Weinberg, P. K. Canavan, and C. Mavroidis, “Active knee rehabilitation orthotic device with variable damping characteristics implemented via an electrorheological fluid,” IEEE/ASME transactions on Mechatronics, vol. 15, no. 6, pp. 952-960, 2009.
[25] J. R. Davidson and H. I. Krebs, “An electrorheological fluid actuator for rehabilitation robotics,” IEEE/ASME Transactions on Mechatronics, vol. 23, no. 5, pp. 2156-2167, 2018.
[26] K. Boku and T. Nakamura, “Development of 3-dof soft manipulator with er fluid clutches,” Journal of intelligent material systems and structures, vol. 21, no. 15, pp. 1563-1567, 2010.
[27] E. W. Schaler, D. Ruffatto, P. Glick, V. White, and A. Parness, “An electrostatic gripper for flexible objects,” in 2017 IEEE/RSJ International Conference on Intelligent Robots and Systems (IROS). IEEE, 2017, pp. 1172 1179.
[28] J. Shintake, V. Cacucciolo, D. Florcano, and H. Shea, “Soft robotic grippers,” Advanced Materials, vol. 30, no. 29, p. 1707035, 2018.
[29] D. M. Aukes, B. Heyneman, J. Ulmen, H. Stuart, M. R. Cutkosky, S. Kim, P. Garcia, and A. Edsinger, “Design and testing of a selectively compliant underactuated hand,” The International Journal of Robotics Research, vol. 33, no. 5, pp. 721-735, 2014.
[30] V. Ramachandran, J. Shintake, and D. Florcano, “All-fabric wearable electroadhesive clutch,” Advanced Materials Technologies, vol. 4, no. 2, p. 1800313, 2019.
[31] R. Hinchet and H. Shea, “High force density textile electrostatic clutch,” Advanced Materials Technologies, vol. 5, no. 4, p. 1900895, 2020.
[32] K. Zhang, E. J. Gonzalez, J. Guo, and S. Follmer, “Design and analysis of high-resolution electrostatic adhesive brakes towards static refreshable 2.5 d tactile shape display,” IEEE transactions on haptics, vol. 12, no. 4, pp. 470-482, 2019.
[33] J. Guo, J. Leng, and J. Rossiter, “Electroadhesion technologies for robotics: A comprehensive review,” IEEE Transactions on Robotics, vol. 36, no. 2, pp. 313-327, 2019.
[34] R. Chen, Z. Zhang, R. Song, C. Fang, D. Sindersberger, G. J. Monkman, and J. Guo, “Time-dependent electroadhesive force degradation,” Smart Materials and Structures, vol. 29, no. 5, p. 055009, 2020.
[35] M. Graule, P. Chirarattananon, S. Fuller, N. Jafferis, K. Ma, M. Spenko, R. Kombluh, and R. Wood, “Perching and takeoff of a robotic insect on overhangs using switchable electrostatic adhesion,” Science, vol. 352, no. 6288, pp. 978 982, 2016.
[36] G. J. Monkman, “An analysis of astrictive prehension,” The International Journal of Robotics Research, vol. 16, no. 1, pp. 1-10, 1997.
[37] J. Guo, T. Bamber, M. Chamberlain, L. Justham, and M. Jackson, “Optimization and experimental verification of coplanar interdigital electroadhesives,” Journal of Physics D: Applied Physics, vol. 49, no. 41, p. 415304, 2016.
[38] S. B. Diller, S. H. Collins, and C. Majidi, “The effects of electroadhesive clutch design parameters on performance characteristics,” Journal of Intelligent Material Systems and Structures, vol. 29, no. 19, pp. 3804-3828, 2018.
[39] J. Guo, T. Bamber, J. Petzing, L. Justham, and M. Jackson, “Experimental study of relationship between interfacial electroadhesive force and applied voltage for different substrate materials,” Applied Physics Letters, vol. 110, no. 5, p. 051602, 2017.
[40] K. H. Koh, M. Sreckumar, and S. Ponnambalam, “Experimental investigation of the effect of the driving voltage of an electroadhesion actuator,” Materials, vol. 7, no. 7, pp. 4963-4981, 2014.
[41] A. P. Chandrakasan, S. Sheng, and R. W. Brodersen, “Low-power cmos digital design,” IEICE Transactions on Electronics, vol. 75, no. 4, pp. 371-382, 1992.

### Experimental Exemplification: Experimental Example 2

I. INTRODUCTION. With the development of collaborative robotics, rehabilitation robots, exoskeletons, and in general robots that share physical workspace with humans, safety has become critically important due to the possibility of physical human-robot interaction (pHRI) [1]. At present, there are several applications where robots work alongside humans, such as monitoring and assistance, rehabilitation, and surgery [2]-[6]. A key requirement in such applications is that the safety of the human(s) involved in the interaction should not be compromised [7], [8]. The need for high speed and high force actuation, which is frequently required for the effective performance of the robot, has been fulfilled in the literature by designing high impedance actuators. However, an actuator with a high impedance in a pHRI is one of the main causes of safety concerns. Thus, future generations of human-safe robots will depend on developing new actuation technologies that can offer inherent safety [9].

Series elastic actuator (SEA) is known as one of the reputable types of actuators designed for applications including interaction with unknown dynamics (which is because of its improved force controllability in comparison to conventional actuators [10]), such as pHRI, e.g. SEA was used for actuation of a knee exoskeleton [11]. Although SEA provides intrinsic passive compliance due to its elasticity, it is not adjustable; thus, limiting its range of application. Variable impedance actuators (VIA) enable adjustable compliments through changing stiffness and damping. VIA is used in a broad range of applications, including haptics, assistive devices, rehabilitation, prosthetics, and exoskeletons [12]. These actuators provide higher levels of pHRI safety than conventional actuators since they mechanically decouple the robot's end effector from the high-impedance gear motor in the system.

Semi-passive actuators could guarantee intrinsic safety not only because of the decoupled end effector from the motor but also because of their passive nature. Magneto-rheological (MR) and electro-rheological (ER) clutches are examples of common types of semi-passive actuators. MR clutches provide torque using the viscous friction of the magneto-rheological fluid between the rotor and stator [9], [13], The amount of dry friction and viscous friction in these types of clutches is adjusted by manipulating the magnetic field inside the clutch. Therefore, a coil is needed inside the clutch to provide the required magnetic field. The need for a coil is the main disadvantage of MR clutches, which makes them heavy and needs high current to generate the required magnetic field. This limits the design parameters and areas of applications, especially in mobile and wearable robotic devices [15], [16]. On the other hand, ER clutches, which are based on the viscous friction of the ER fluid, have been proposed as an alternative to the above-mentioned issue in rehabilitation and assistive robotics [17], [18]. This removes the need for a coil since the viscosity of the ER fluid can be tuned using an electric field. ER clutches have been used in multiple assistive and rehabilitation robotics applications [17], [18]. However, the low viscosity of the ER fluid limits the output torque of the clutch. In addition, high voltage (in the range of kV) is required to generate the needed electric field.

Force resulting from electroadhesion (EA) can be generated without the need for heavy parts and high currents. With a proper selection of a dielectric, noticeable attraction force was achieved under a relatively low voltage (below 300 volts) [19]. This force was harnessed in various applications mostly to generate friction [20]. The ultra-lightweight and the low power consumption of EA have attracted a great deal of interest, mostly in wearable robotics. In [21], miniature EA clutches were employed as a joint locking mechanism in a robotic hand. In [19], [22], a translational lightweight EA clutch was described and used in an ankle exoskeleton. EA was used as a braking mechanism for a 2.5D haptics display [23]. A high force density wearable EA clutch was utilized in [24] for haptic gloves. A wearable linear EA clutch was developed and implemented in an elbow haptic device [25], [26]. Feasibility analysis of a rotational EA clutch has been conducted in [27]. An adaptive damper using EA is developed in [28]. Except in [28], the above-mentioned EA actuators were implemented in on/off mode as a locking mechanism by utilizing static friction without the ability to tune the actuation force/torque.

The lack of research on adjustable EA clutches may be due to the issue of the space charge build-up in the friction interface as reported in [21], [23], [24], [29]-[31] and our previous work [32; i.e., Experimental Example 1]. The space charge build-up in the dielectric causes the degradation of the attraction force when the clutch is activated. In addition, it creates residual force when the clutch is disengaged after an active period. These issues complicate the modeling of EA clutches, especially when the underlying force generation mechanism of the clutch is through sliding friction [29].

II. ELECTROADHESIVE CLUTCH AND THE EXPERIMENTAL SETUP. The EA clutch transfers force/torque using dry sliding friction between the two clutch plates. When high voltage is applied across the clutch plates, the electroadhesion due to the static charges on the clutch plates creates a strong attraction force. A dielectric is used between the plates to provide electric isolation and prevent electric discharge. Therefore, an attraction force can be maintained when a high voltage is applied across the plates. This normal force due to electroadhesion leads to friction that couples the motion of the input and output clutch plates (see for detail).

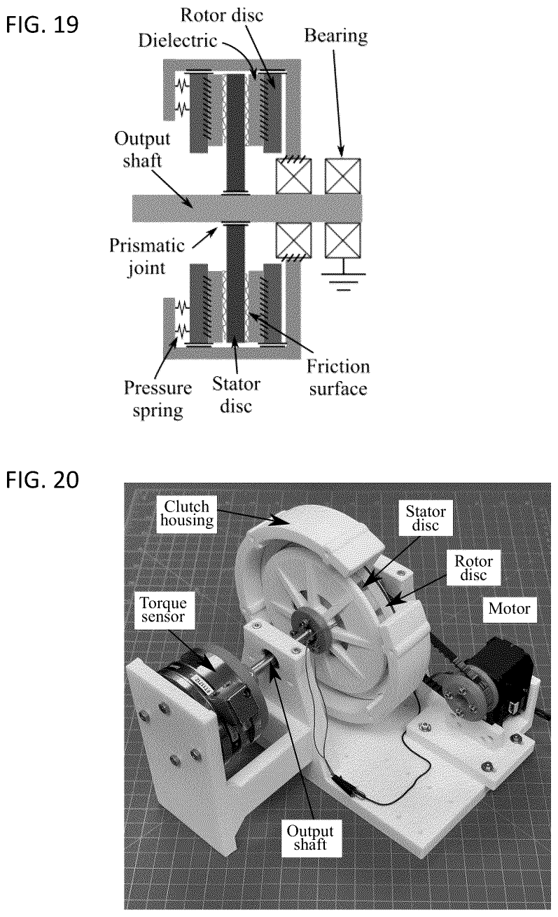

In this paper, we used a rotary EA clutch to verify the performance of the proposed method. The core of the rotary EA clutch is comprised of: (1) two rotor discs; (2) a stator disc (rotor and stator discs are made of 0.1 mm thick 1095 Spring steel (Mc-Master Carr, ON, Canada)); and (3) a machined splined rotary shaft (see FIG. 19). The thickness of the discs and their material are selected such that they provide enough flexibility for the disc in the axial direction to fill the air gap between the rotor and the stator under electroadhesion while providing enough stiffness in the tangential direction to transfer torque. The rotor discs are mounted on the clutch housing and the output of the drive motor of the test-setup. Rotors are mounted such that they rotate with the housing but they can slide axially to fill the air gap between discs, as shown in FIG. 19. The stator disc, which is sandwiched between two rotor discs, is mounted on the output shaft using a 3D printed connecting part, which transfers the torque from the disc to the shaft while enabling it to slide axially on the shaft. The rotor discs were coated with 95 μm DuPont 8153 dielectric before being cut to shape using electric discharge machining. The coating procedure was done through application of five layers of 25 μm (wet thickness) dielectric film to reach the expected thickness [22]. FIG. 20 shows the fabricated test-setup.

An ideal separation between the stator and the rotor discs is to be maintained so that friction and wear of the discs can be avoided when the clutch is disengaged. However, keeping a zero gap between the discs will maximize the EA forces and the clutch response time. In order to address these two competing design requirements, pressure springs were utilized to apply enough pressure to minimize the air gap while avoiding significant wear and friction when the clutch is in free motion (see FIG. 19).

The rotor discs have an inner diameter of 8 cm and the stator disc has an outer diameter of 12 cm, creating a ring-shaped friction area of the same inner and outer diameters. Details of the design of the rotary clutch with one friction surface are given in [32; i.e., Experimental Example 1]. However, in this research, two rotor discs and both sides of the stator disc were used to double the friction area and the maximum achievable torque. Thus the dielectric was applied on the rotor discs instead of the stator disc. The formulation of the maximum achievable torque is as follows:

$$T = \frac{2 π ( {r}_{3}^{2} - {r}_{1}^{3} ) {σ}_{sh} n}{3} \qquad ( 1 )$$

where r1 and r2 are the inner and outer radii of the friction ring, σsh is the shear stress, and n is the number of friction surfaces, which is equal to 2 in this design.

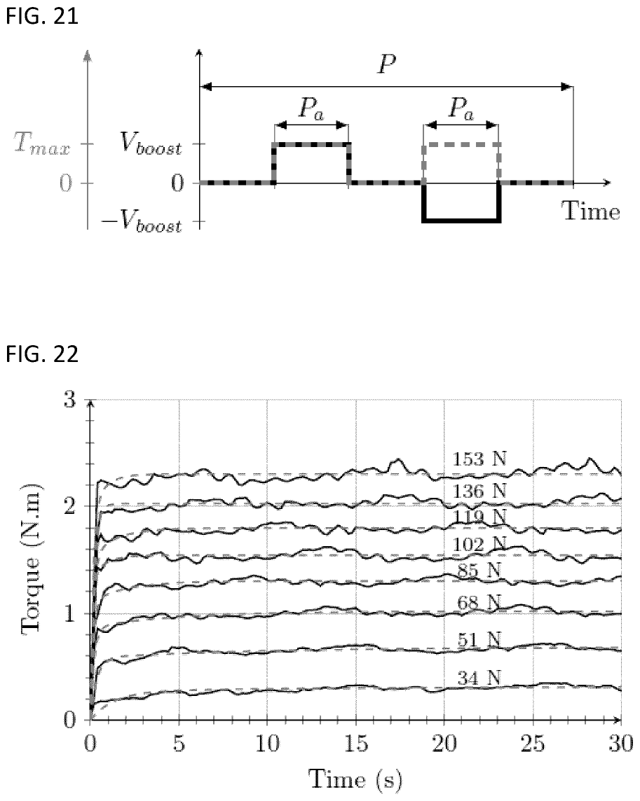

A custom high-voltage driver circuit was used to activate the EA clutch. The main components of the driver circuit are: (1) a PHV 12 DC-DC high voltage transformer (Bellnix Co., Saitama, Japan); (2) a high-voltage H-Bridge made of IKW50N65 IGBTs (Infineon Technologies, Neubiberg, Germany), to enable activation of the clutch under PWM signal; and (3) An arduino controller to interface the driver to the computer. Data acquisition and controller calculations were done in real-time with the loop frequency of 1 kHz using QuaRC real-time control software (Quanser, ON, Canada) in the MATLAB Simulink environment. The driver circuit gets the amplitude, frequency, and duty cycle of the target PWM signal from the computer through the serial bus. FIG. 21 shows one period of the generated signal along with the expected ideal torque. The duty cycle of the PWM signal calculates as follows:

$$Duty cycle = \frac{2 {P}_{a}}{P} \qquad ( 2 )$$

The frequency of the PWM signal is selected as 300 Hz in all experiments. An ATI Gamma sensor is connected to the output shaft of the clutch to measure the feedback output torque.

III. FRICTION MODELING. In this section, the characteristics of the friction between the clutch discs (which is dielectric against steel) for one friction interface are investigated. This has been done by analyzing the effect of the normal force and the rotation velocity on the torque. A kinetic friction model mapping the normal force to the output torque of the clutch is proposed.

In order to measure the friction, the electroadhesion part of the clutch is bypassed and a constant normal force is applied to push the discs together using weights. This was done utilizing a lever mechanism with an advantage ratio of 4.33 to amplify the force due to weights.

A. Normal force effect. In order to evaluate the effect of the normal force, each experiment was carried out under a constant rotation velocity of 15 RPM. Different normal forces ranging from 17 to 170 N (equivalent to average stress ranging from 2.7 to 27 KPa) were applied on the discs. For the sake of brevity, only some of the recorded data are shown in FIG. 22. As can be seen in the figure, the torque demonstrates a dynamic behavior which can be partially due to the stiffness of the system components, including rotating parts and the lever mechanism. However, most of the dynamic behavior of the torque is due to the friction interface, as will be explained in Section III.B.

A function comprised of two exponential components, as below is proposed to model the torque due to friction.

$$T ( t , f ) = ( C ( 1 - {e}^{- t / {τ}_{1} ( f )} ) + ( 1 - C ) ( 1 - {e}^{- t / {τ}_{2} ( f )} ) ) {T}_{s} ( f ) \qquad ( 3 )$$

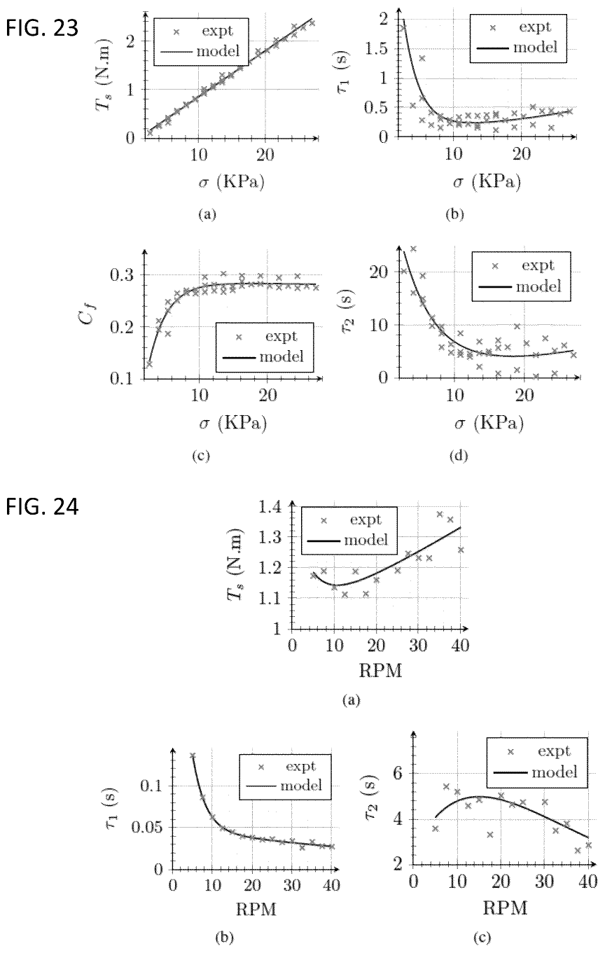

In (3), the first term in the parentheses is related to the fast dynamics of friction and the second term is associated with the slow dynamics, t denotes time, f is the normal force, Ts is the torque achieved at the end of each experiment, τ1 and τ2 are time constants, and C is the factor that adjusts the portion of the fast dynamics. To identify the model parameters, (3) is fitted to the recorded data for each experiment using sequential quadratic programming (SQP). In order to reduce the degree of freedom of the problem and avoid overfitting, a constant value 0.85 is selected for C through observations. Ts, τ1, and τ2 are determined as shown in FIG. 23 for each experiment. The model parameters are show in Table 2. From FIG. 23(b) and FIG. 23(d) it can be seen that the torque dynamics are sluggish under smaller normal stresses. However, when the stress increases, τ1 and τ2 reduce to around 0.3 and 4 seconds, respectively. This means that friction increases up to 85% with the time constant of 0.3 s, and the rest of the torque will be achieved with slower dynamics with a time constant of 4 s.

TABLE 2
Identified parameters of the friction model.

| parameter | model | fit rmse |
|---|---|---|
| Tₛ | 0.0944σ − 0.0896 | 0.323 |
| C_{f} | 0.29e^{-0.000725σ} − 0.42e^{-0.337σ} | 0.0127 |
| τ₁ | 6.01e^{-0.431σ} + 0.11e^{0.0492σ} | 0.277 |
| τ₂ | 40.25e^{-0.219σ} + 1.37e^{0.0476σ} | 2.67 |

FIG. 23(c) shows the coefficient of friction. As can be seen in the figure, within the observed range, Cf increases with the increase of the normal stress and reaches a saturated value. This effect might be due to the imperfect friction surface which prevents engagement of the full area of the discs, leading to a smaller effective friction area. However, as the rotor disc is designed to be flexible, it deflects and fills the gaps when normal stress increases. This results in more effective friction surface and thus a higher friction coefficient up to the saturation value (which can be when the total area of the discs is engaged).

B. Velocity Effect. One of the factors affecting friction is sliding velocity. In order to investigate this effect, a series of experiments were conducted in which the clutch was rotated with a constant velocity for 70 s and a constant normal force of 86 N was applied on the discs from t=10 s to the end of the experiment. This experiment was repeated for velocities ranging from 5 to 40 RPM.

FIG. 24(a) shows the achieved maximum torque for different rotation velocities. The black line shows the second-order exponential model fitted to the experimental data using SQP algorithm. Parameters of the fitted model are shows in Table 3. As can be seen in the figure, when the velocity is below 12 RPM, the torque reduces with the increase of the velocity; however, the torque increases almost linearly with the increase of the velocity when the velocity is above 12 RPM. This is mainly because of the viscous component of friction [35]. FIG. 24(b) and FIG. 24(c) show the identified time constants for different velocities. Comparing the order of variations of τ1 and τ2 in FIG. 24 with the same in FIG. 23, it can be seen that the effect of the rotation velocity on the dynamics of the torque is noticeably less than the effect of the normal force. From the small variation of the time constant with change in velocity, it can be inferred that the stiffness of the rotating components is not a major contributor to the whole dynamics of the system.

TABLE 3
Identified parameters of the friction model.

| parameter | model | fit rmse |
|---|---|---|
| Tₛ | 0.349e^{-0.230σ} + 1.042e^{0.00608σ} | 0.0523 |
| τ₁ | 0.425e^{-0.310σ} + 0.0498e^{-0.0150σ} | 0.0020 |
| τ₂ | 5.375 × 10⁵e^{-0.0507σ} − | 0.850 |
| | 5.374 × 10⁵e^{-0.0507σ} | |

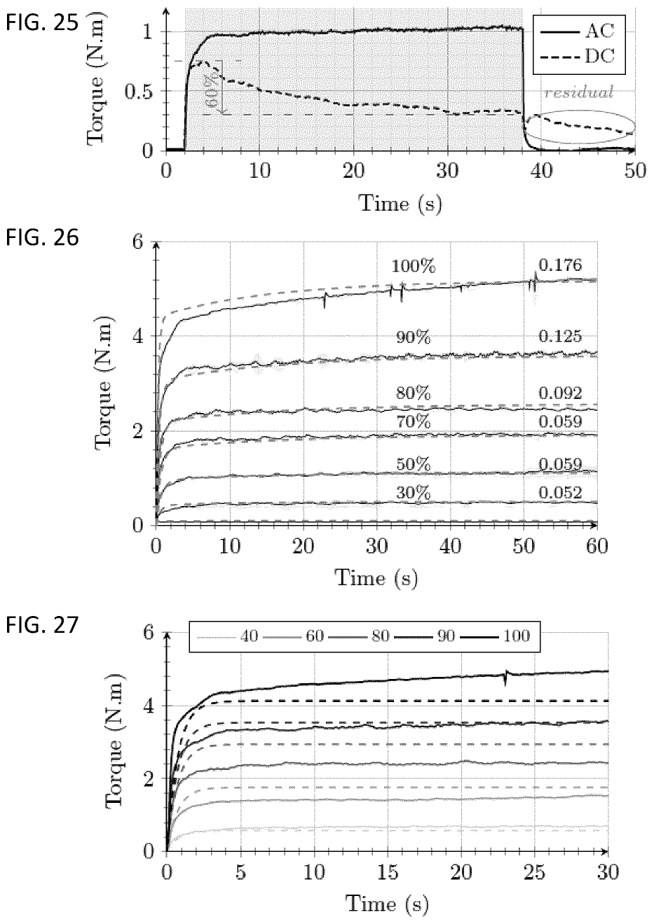

IV. CLUTCH MODEL IDENTIFICATION. The EA clutch can be activated under direct current (DC) or alternating current (AC), each of which exhibits a unique behavior. Utilizing DC activation signal leads to space charge build-up in the dielectric [30], [32; i.e., Experimental Example 1]. The accumulated charges create an electric field counteracting the electric field generated by the charges on the disc. The dynamics of formation and degradation of the space charges in the dielectric are much slower than those of the electric charges on the conductive part of the discs. Thus, it causes torque degradation with the passage of time when the clutch is engaged. It also causes undesirable residual torque after the onset of deactivation of the clutch (see FIG. 25). Both of the above-mentioned issues were addressed by using AC activation signals [32; i.e., Experimental Example 1]. Thus, in this paper, only AC activation is considered for modeling and control. In this section, a nonlinear and a linear model are proposed to map the control signal to torque.

A. Nonlinear Model. Prior to model identification, an experiment was carried out to measure the torque variation with time as a function of the control signal (PWM duty cycle). In the experiment, the clutch was rotated idly with a constant velocity of 10 RPM for 10 seconds. Then it was activated with 600 V peak-topeak bipolar PWM signal (see FIG. 21) by a increase of duty cycle to the target value with a step function. This procedure was repeated for duty cycles ranging from 10 to 100. Each experiment was repeated three times, and the average values were used for model identification. FIG. 26 shows the average of the measured values along with their standard deviation. Since the output torque did not vary significantly in smaller duty cycles, the results for the lower duty cycles are eliminated for the sake of brevity.

A nonlinear model, as shown in (4), is fitted on the recorded values using SQP algorithm.

$$T ( t , u ) = ( C ( 1 - {e}^{- t / {τ}_{1} ( u )} ) + ( 1 - C ) ( 1 - {e}^{- t / {τ}_{2} ( u )} ) ) {T}_{s} ( u ) \qquad ( 4 )$$

The model and parameters in (4) are the same as in (3). The only difference is the input u, which is the control signal (PWM duty cycle) instead of the normal force. The variations of τ1, τ2, and Ts with the control signal are modeled with polynomials of orders 2, 2, and 3, respectively, as shown below:

The

$${τ}_{1} ( u ) = {a}_{2} {u}^{2} + {a}_{1} u + {a}_{0} \qquad ( 5 )$$

$${τ}_{2} ( u ) = {b}_{2} {u}^{2} + {b}_{1} u + {b}_{0} \qquad ( 6 )$$

$${τ}_{s} ( u ) = {c}_{3} {u}^{3} + {c}_{2} {u}^{2} + {c}_{1} u + {c}_{0} \qquad ( 7 )$$

identified parameters of the proposed nonlinear model are shown in Table 4. The overall estimation error of the proposed nonlinear model is 0.088 N·m. The estimated torque with respect to time using the nonlinear model and the estimation error of the model for each input signal are shown in FIG. 26. It can be seen that the nonlinear model follows the experimental results accurately.

TABLE 4
Identified parameters of the nonlinear clutch model.

| symbol | value |
|---|---|
| a0 | 6.74 × 10⁻³ |
| a1 | 2.39 × 10⁻² |
| a2 | −2.13 × 10⁻⁴ |
| b0 | 0.93 |
| b1 | 0.41 |
| b2 | −2.64 × 10⁻³ |
| c0 | −1.19 × 10⁻² |
| c1 | 1.81 × 10⁻³ |
| c2 | −2.97 × 10⁻⁵ |
| c3 | 1.85 × 10⁻⁷ |
| C | 0.85 |

B. Linear Model Estimation. The model in (4) describes the torque variation with time and control signal. However, the complexity of the model increases the computational cost of the controller. Thus, a simplified first-order linear model is proposed as shown below:

$${T}^{\cdot } = - {a}_{0} T + {b}_{0} u + {c}_{0} \qquad ( 8 )$$

where T is the torque, u is the control signal, a0, b0, and c0 are the model parameters that are identified using SQP algorithm. The identified parameters are shown in Table 5. The estimated torque and associated experimental values are shown in FIG. 27. As can be seen, the linear model can only estimate the output torque accurately when the control signal is close to 40 or 90. This straightforward model is used for the implementation of an RC in the rest of the paper.

TABLE 5
Identified parameters of the linear clutch model.

| symbol | value |
|---|---|
| a₀ | 1.36 |
| b₀ | 0.08 |
| c₀ | −2.42 |

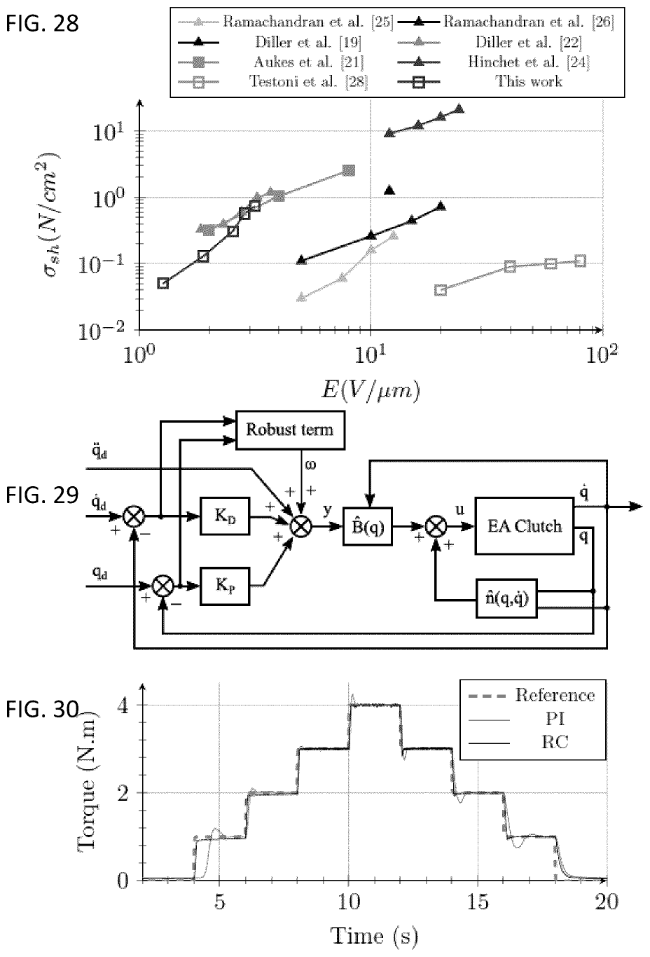

FIG. 28 shows the friction shear stress vs. electric field for the prominent EA actuator presented in the literature along with our clutch. As can be seen in the figure, shear stress per electric field achieved in our design is close to the maximum value reported in [21], which is remarkably higher than the shear stress reported in [19], [25], [26], [28]. It should be noted that, in contrast with the actuators presented in the literature that are locking actuators, which work based on static friction, our clutch is adjustable and works based on the sliding friction, which is naturally lower than static friction [35].

V. ROBUST CONTROLLER DESIGN. In this section, an RC based on the linear model identified in (8) is implemented to control the output torque of the clutch. Although the nonlinear model in (4) better addresses the variations in the torque in comparison to the linear model, the implementation of a controller based on the nonlinear model is computationally intensive and increases the complexity of the control system. Thus, the linear model is used in the controller design procedure. However, the linear model contains uncertainties due to the linearization, unmodeled dynamics, and intrinsic uncertainties resulting from friction. In order to compensate for the uncertainties of the system and guarantee performance, the Lyapunov function redesign approach [36], [37] was used in this paper. The performance of the proposed controller is compared with that of a PI controller [38].

A. Robust Controller. In order to make the model compatible with the controller design procedure [37], we consider the torque control problem in an analogous manner to a joint velocity control problem. Thus, the torque variable T changes to the analogous joint velocity variable q′. Equation (8) can be written in the form

$$B ( q ) {q}^{\cdot \cdot } + η ( q , {q}^{\cdot } ) = u \qquad ( 9 )$$

$$where$$

$$B = \frac{1}{{b}_{0}}$$

$$and$$

$$η = \frac{1}{{b}_{0}} ( {a}_{0} \dot{q} - {c}_{0} )$$

However, there exist uncertainties in the analogous model parameters B and n. Therefore (9) should be written as

$$B \hat{} ( q ) {q}^{\cdot \cdot } + η \hat{} ( q , {q}^{\cdot } ) = u \qquad ( 10 )$$

where B\hat{ } and η\hat{ } are the estimated values for B and n. Equation (10) leads to the nonlinear control law given below following the standard inverse dynamics control approach.

$$u = By \hat{} + η \hat{} ( q , {q}^{\cdot } ) \qquad ( 11 )$$

$$where$$

$$y = {{q}^{\cdot \cdot }}_{d} + {K}_{D} {q}^{∼ \cdot } + {K}_{P} {q}^{∼} + ω \qquad ( 12 )$$

in that q\ddot{ }_{d} is the feedforward desired signal, q\tilde{ }=q_{d}−q is the error, and K_{P} and K_{D} are the proportional-derivative (PD) controller design parameters. It should be noted that according to the q\dot{ }=T analogy, the PD controller implemented on the variable q is equivalent to a PI controller on the actual clutch output T. In (12), the PD term KDq\tilde{ }+KPq\tilde{ } ensures stabilization of the error dynamics and the term ω provides the robustness of the controller against a predefined range of uncertainties in model estimation (see for detail).

In an ideal scenario, the control law

$$ω = \frac{ρ}{‖ z ‖} z$$

(where z=DTQξ, D=[0,1]T, Q is a (2n×2n) positive definite matrix, and ξ=[q\tilde{ }, q\tilde{ }\dot{ } ]T) would compensate for the uncertainties. However, in order to avoid the generation of the high frequency components due to chattering in the control signal, when z converges to zero, and also because of actuator limitations, the effort of the robust control term is limited to

$$\frac{ρ}{ϵ} z$$

when z is less than the threshold. The signal transformation from the above-mentioned control law to the limited value is implemented using a tanh soft switch. Thus, the formulation of the RC law is as follows:

$$ω = S \frac{ρ}{‖ z ‖} z + ( 1 - S ) \frac{ρ}{ϵ} z \qquad ( 13 )$$

$$where$$

$$S = \frac{tan h ( γ ( z - ϵ ) ) + 1}{2} \qquad ( 14 )$$

and γ adjusts the speed of the transition between the first term and the second term of the right side of (13)—the higher the value of γ the faster will be the transition.

Using the control law (13), the convergence of the error can be guaranteed through Lyapunov stability theory if the condition ρ>kηk is satisfied. This can be rewritten as the inequality below [37]:

$$ρ \geq \frac{1}{1 - α} ( α {Q}_{M} + α ‖ K ‖ ‖ ξ ‖ + {B}_{M} ϕ ) \qquad ( 15 )$$

$$where$$

$$\{ \begin{matrix}{\ddot{q}}_{d} < {Q}_{M} & ( 16 a ) \\ ‖ η - \hat{η} ‖ \leq ϕ & ( 16 b ) \\ α = \frac{{B}_{M} - {B}_{m}}{{B}_{M} + {B}_{m}} & ( 16 c )\end{matrix}$$

and Bm and BM are the lower and upper bounds of the variation of B″, respectively, and K=15 [KP,KD]. FIG. 29 shows the block diagram of the control system.

In order to find Bm and BM, (8) was fitted to the experimental data for each input signal individually; Bm and BM were estimated to be 12.4 and 42.6, respectively, according to the range of the variations in b0; QM was selected to be 5 based on the range of the accelerations of the expected input trajectory; and φ was selected through observation of the performance of the controller. A larger value of φ results in a larger control signal [39]. However, due to the limitations of the applicable range of the actuators, increasing φ may lead to chattering. Thus, φ was selected to be 0.05 to avoid chattering. All controller parameters are shown in Table 6.

TABLE 6
Identified parameters of the robust controller.

| symbol | value | symbol | value |
|---|---|---|---|
| Bₘ | 12.4 | ϵ | 0.5 |
| B_{M} | 42.6 | γ | 50 |
| Q_{M} | 5 | K_{D} | 3 |
| φ | 0.05 | K_{P} | 4.5 |

B. PI Controller. A PI controller is also implemented to compare with the performance of the RC. Due to the friction-based physics of the clutch (a) there was enough damping in the system, (b) there was high-frequency components (due to the sliding of two surfaces of the clutch) which could be amplified by a derivative term. Because of the two reasons mentioned above, we utilized a PI controller to compare it with the robust controller. On the other hand, as mentioned in Section V-A, the integrated PD controller implemented on the variable q in the RC is actually a PI controller on the actual clutch torque T. Therefore, comparing the RC with a PI controller demonstrates the effect of the robust term of the RC. The PI controller parameters are tuned based on the estimated linear model in (8) to reach 1% overshoot and settling time equal to 0.27 s. The calculated control parameters KP and KI were determined to be 21 and 360, respectively.

VI. CONTROLLER EXPERIMENTAL RESULTS AND DISCUSSION. In this section, the performance of the RC is examined and compared with PI for different torque trajectories.

In the first experiment, an increasing and decreasing step trajectory ranging from 0 to 4 Nm is used as the reference signal to evaluate the system's performance. Results are shown in FIG. 30. As can be seen in the figure, using the RC resulted in a shorter rise time with negligible overshoot compared to using the PI controller. More significantly, the variation in the torque after reaching the reference value in each step, which might be because of the uncertainties due to friction (see torque variation in FIG. 22), is eliminated using the RC. The slow settling time in the last decreasing step is due to the intrinsic sluggish dynamics of the friction under lower normal forces (see FIG. 23(b) and FIG. 23(d)). This cannot be compensated as the actuator is limited to its lower bound.

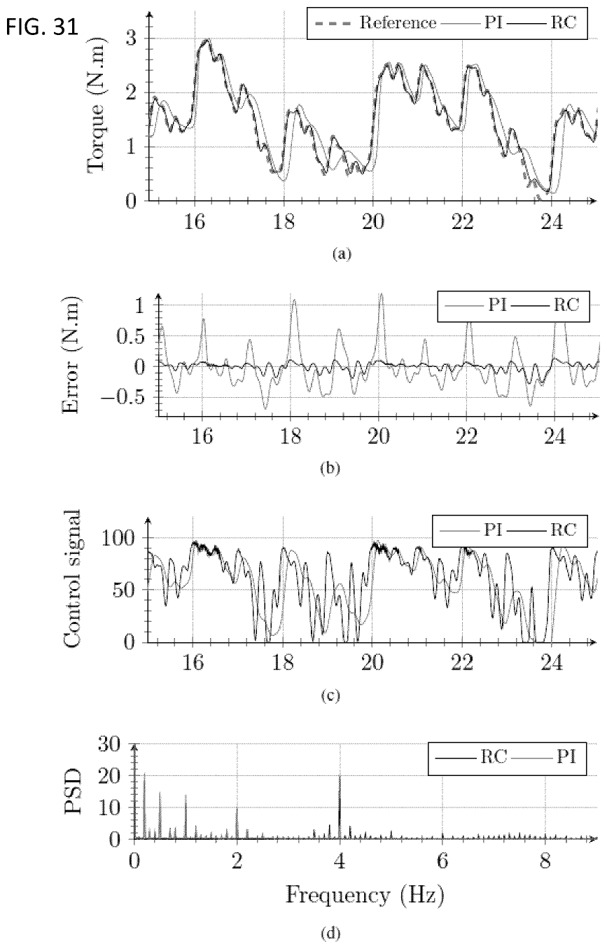

To investigate the controller performance further, a multidimensional reference trajectory consisted of sinusoidal components with frequencies ranging from 0.2 to 4 Hz is fed to the system. FIG. 31(a) shows the output torques. As can be seen in the figure, the RC tracks the reference signal accurately; however, a phase lag and higher tracking error can be seen for the PI controller. The PI controller phase lag can be because of the relatively larger settling time. However, designing the controller to reach a faster settling time while keeping the control signal in the limited range of the actuator would result in even larger overshoots. The observed overshoot from the experimental data is higher than what the PI is tuned for (1%). This behavior can be explained according to the unmodeled nonlinear dynamics of the clutch in case of using a PI controller. The tracking error is more clearly shown in FIG. 31(b). The amplitude of the tracking error for the RC is limited to 0.2 Nm, which is 83% less than for the PI controller, which is 1.2 Nm. FIG. 31(c) shows the control signal for both controllers. FIG. 31(d) shows the power spectrum of the control signal. As can be seen, the RC signal includes higher frequency components in comparison to that for the PI controller.

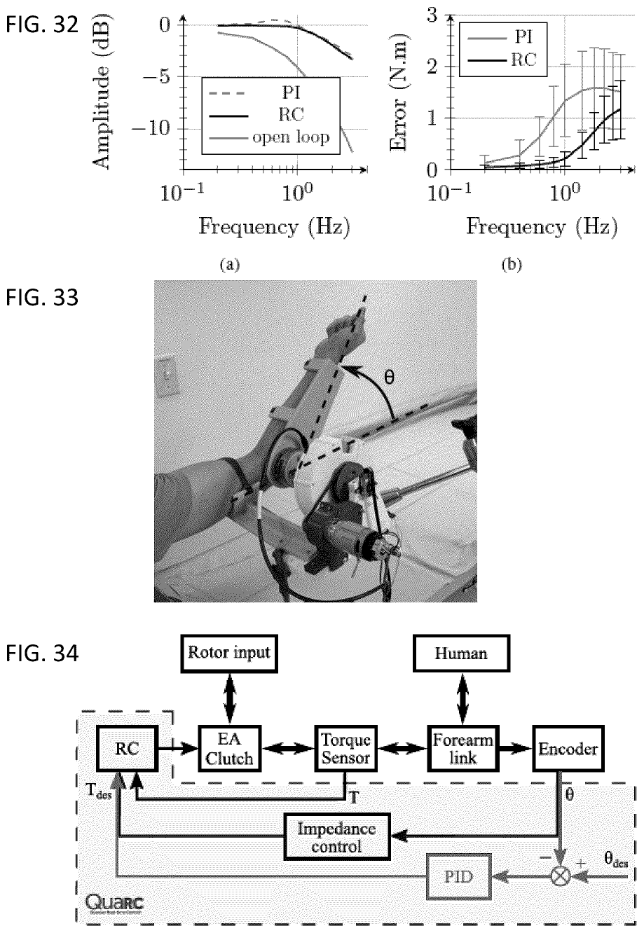

Sinusoidal reference signals with frequencies ranging from 0.2 to 3 Hz and amplitude of 2 are used to evaluate the frequency response of the clutch with the RC. The same experiment was also repeated in open-loop and using the PI controller to compare with the RC. The results are shown in FIG. 32. FIG. 32(a) shows the amplitude of the output torque in decibels. It can be seen that the implementation of the RC and PI controller improved the frequency response of the system. However, overshoots can be seen in the figure for frequencies close to 0.6 Hz when using the PI controller. Negligible degradation in amplitude was observed up to 1 Hz. FIG. 32(b) shows the absolute tracking error. As can be seen, the RC tracking error is much less than that of the PI controller.

VII. REHABILITATION EXPERIMENT AND DISCUSSION. In this section, the performance of the EA clutch in two different training modalities of active-resistive and coordinative-assisted (path guidance) rehabilitation is validated.

A stationary elbow exoskeleton was made using the EA clutch, as shown in FIG. 33. The stator of the clutch was connected to the forearm link through an ATI gamma force/torque sensor. The arm and forearm of a healthy user were attached to the arm link and the forearm link, respectively, using Velcro straps. An incremental encoder was used to measure the forearm angle. A DC motor was used to rotate the rotor of the clutch. According to the direction of the rotation of the rotor, the rehabilitation device can apply flexion and extension torque to the user's forearm (The rotation of the rotor in the direction of flexion of the forearm is assumed positive).

In an active-resistive rehabilitation scenario, the user was asked to move their forearm on a sinusoidal reference trajectory with a frequency of 0.4 Hz while the robot actively resisted the user's forearm motion. The purpose of this exercise is to increase the trajectory tracking error, which leads to reinforcement of the biceps and triceps muscles for cases with the ability to deliver muscle activity [33]. Thus, during the experiment, the robot applies a resistive torque against the user's motion [6]. [40]. In this experiment, the resistive torque was applied only in the direction of the extension of the forearm. Thus, the rotor of the clutch was rotated with constant negative velocity. A virtual environment was implemented for θ≥10° to resist the flexion of the forearm. Soft (stiffness=1 N·m/rad) and hard (stiffness=3 N·m/rad) environments were implemented using an impedance control. FIG. 34 shows the diagram of the control system.

In a coordinative rehabilitation scenario, the user's motion was promoted and coordinated with the robot to track a prescribed trajectory, and the user was asked to remain passive during the experiment (This type of exercise is designed for patients unable to activate their forearm muscles [34], [40], [41]). The rotor of the clutch was rotated with positive constant velocity, and thus the robot applied a positive torque to move the user's forearm. A PID controller was used to coordinate the user's forearm on a sinusoidal trajectory by controlling the lower bound of the forearm angle (see FIG. 34).

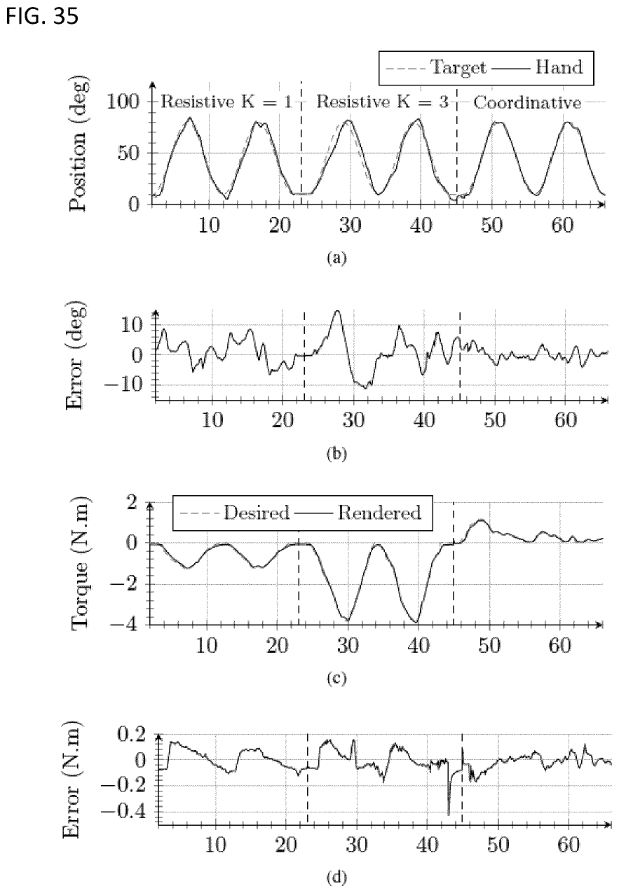

FIG. 35 shows the results for the experiments. The area from t=0 to t=22.5 s shows the resistive rehabilitation with the soft environment, the area from t=22.5 to t=45 shows the resistive rehabilitation with the hard virtual environment, and the area from t=45 to t=67.5 shows the coordinative-assisted rehabilitation. FIG. 35(a) shows the target trajectory and the forearm angle. FIG. 35(c) shows the desired torque, which is calculated by the impedance controller in the active-resistive rehabilitation and the PID controller in the coordinative rehabilitation scenario. Negative torque refers to the effort of the robot in the extension of the forearm, and positive torque refers to the effort of the robot in the flexion of the forearm. FIG. 35(c) also shows the rendered torque, which was controlled by the low-level RC. As can be seen in the figure, the rendered interaction torque perfectly follows the desired trajectory both in the active-resistive and coordinative-assisted modalities.

FIG. 35(b) shows the position tracking error. As seen, the position tracking error increases with the increase of the environment stiffness in resistive rehabilitation. However, no remarkable difference can be seen in the torque tracking error between hard and soft environments, as shown in FIG. 35(d). This is the desired outcome, which is due to the high resistive force applied by the robot to the user's forearm. On the other hand, it can be seen that the position tracking error in coordinative training is less than in resistive therapy since the robot assists in moving the user's forearm on the trajectory. These results can be seen more clearly in FIG. 36 which shows the box plot of the absolute position tracking error. The student's T-test was performed after the validation of the normality of the absolute tracking error of each experiment (for the soft resistive environment, p-value=0.006; for the hard resistive and coordinative scenario, p-value<0.001). A significant absolute tracking error difference was observed between the results for experiments with different environment stiffness (p-value=0.003) and between the results for resistive and coordinative rehabilitation (p-value<0.001 for both cases) experiments. These results demonstrate the desired performance of the proposed wearable rehabilitation device in increasing the position tracking error in target tracking resistive rehabilitation scenarios and manipulating the user's forearm in a coordinative-assisted scenario.

VIII. CONCLUSION. An efficient high-fidelity robust control approach was presented to control an electroadhesive clutch. In the first step, the friction between the clutch plates was studied, and a nonlinear friction function was proposed to model the time-dependent behavior of friction. It was observed that the friction dynamics are nonlinearly dependent on the normal force. In order to control the clutch, a novel activation signal using a special bipolar PWM scheme was used to address the electroadhesion degradation issue, as well as allowing the duty cycle of the PWM signal to be adjusted to tune electroadhesion. Then, an accurate nonlinear model, and a simplified linear model were identified for estimating the torque from the control signal. A robust controller based on the simplified linear model was implemented, and the results were compared to a PI controller. The results showed that when using the robust control approach, the clutch follows a multi-sinusoidal trajectory perfectly. The performance of the proposed control, along with an electroadhesive clutch as a semi-passive actuator, was experimentally validated in active-resistive and coordinative-assisted rehabilitation scenarios. The results showed that this technology can be used in safe physical human-robot interaction systems, such as exoskeletons, rehabilitation, and assistive robots.

### IX. Reference List for Experimental Example 2

[1] A. Zacharaki, I. Kostavelis, A. Gasteratos, and I. Dokas, “Safety bounds in human robot interaction: A survey,” Safety science, vol. 127, p. 104667, 2020.
[2] N. Fcizi, M. Tavakoli, R. V. Patel, and S. F. Atashzar, “Robotics and AI for teleoperation, tele-assessment, and tele-training for surgery in the era of COVID-19: existing challenges, and future vision,” Frontiers in Robotics and AI, p. 16, 2021.
[3] C. Nicholson-Smith, V. Mchrabi, S. F. Atashzar, and R. V. Patel, “A multi-functional lower- and upper-limb stroke rehabilitation robot,” IEEE Transactions on Medical Robotics and Bionics, vol. 2, no. 4, pp. 549-552, 2020.
[4] A. Brodie and N. Vasdev, “The future of robotic surgery,” The Annals of The Royal College of Surgeons of England, vol. 100, no. Supplement 7, pp. 4-13, 2018.
[5] B. Noronha and D. Accoto, “Exoskeletal devices for hand assistance and rehabilitation: a comprehensive analysis of state-of-the-art technologies,” IEEE Transactions on Medical Robotics and Bionics, 2021.
[6] C. Rossa, M. Najafi, M. Tavakoli, and K. Adams, “Robotic rehabilitation and assistance for individuals with movement disorders based on a kinematic model of the upper limb,” IEEE Transactions on Medical Robotics and Bionics, vol. 3, no. 1, pp. 190-203, 2021.
[7] T. B. Sheridan, “Human-robot interaction: status and challenges,” Human Factors, vol. 58, no. 4, pp. 525-532, 2016.
[8] T. Haidegger, “Autonomy for surgical robots: Concepts and paradigms,” IEEE Transactions on Medical Robotics and Bionics, vol. 1, no. 2, pp. 65-76, 2019.
[9] A. S. Shafer and M. R. Kermani, “On the feasibility and suitability of mr fluid clutches in human-friendly manipulators,” IEEE/ASME Transactions on Mechatronics, vol. 16, no. 6, pp. 1073-1082, 2010.
[10] J. Pratt, B. Krupp, and C. Morse, “Series elastic actuators for high fidelity force control,” Industrial Robot: An International Journal, 2002.
[11] S. V. Sarkisian, M. K. Ishmael, G. R. Hunt, and T. Lenzi, “Design, development, and validation of a self-aligning mechanism for hightorque powered knee exoskeletons,” IEEE Transactions on Medical Robotics and Bionics, vol. 2, no. 2, pp. 248-259, 2020.
[12] B. Vanderborght, A. Albu-Schaffer, A. Bicchi, E. Burdet, D. G. Cald-” well, R. Carloni, M. Catalano, O. Eiberger, W. Friedl, G. Ganesh, et al., “Variable impedance actuators: A review,” Robotics and autonomous systems, vol. 61, no. 12, pp. 1601-1614, 2013.
[13] N. Najmaei, A. Asadian, M. R. Kermani, and R. V. Patel, “Design and performance evaluation of a prototype MRF-based haptic interface for medical applications,” IEEE/ASME Transactions on Mechatronics, vol. 21, no. 1, pp. 110-121, 2015.
[14] S. Pisetskiy and M. Kermani, “High-performance magneto-rheological clutches for direct-drive actuation: Design and development,” Journal of Intelligent Material Systems and Structures, p. 1045389X211006902, 2021.
[15] C. Khazoom, P. Caillouette, A. Girard, and J.-S. Plante, “A supernumerary robotic leg powered by magnetorheological actuators to assist human locomotion,” IEEE Robotics and Automation Letters, vol. 5, no. 4, pp. 5143-5150, 2020.
[16] J. Li, L. Zhao, and T. Li, “Robotic walker for slope mobility assistance with active-passive hybrid actuator,” Chinese Journal of Mechanical Engineering, vol. 34, no. 1, pp. 1-10, 2021.
[17] J. R. Davidson and H. I. Krebs, “An electrorheological fluid actuator for rehabilitation robotics,” IEEE/ASME Transactions on Mechatronics, vol. 23, no. 5, pp. 2156-2167, 2018.
[18] R. Chaichaowarat, S. Nishimura, and H. I. Krebs, “Macro-mini linear actuator using electrorheological-fluid brake for impedance modulation in physical humanrobot interaction,” IEEE Robotics and Automation Letters, 2022.
[19] S. Diller, C. Majidi, and S. H. Collins, “A lightweight, low-power electroadhesive clutch and spring for exoskeleton actuation,” in 2016 IEEE International Conference on Robotics and Automation (ICRA), pp. 682-689, IEEE, 2016.
[20] J. Guo, J. Leng, and J. Rossiter, “Electroadhesion technologies for robotics: A comprehensive review,” IEEE Transactions on Robotics, vol. 36, no. 2, pp. 313-327, 2019.
[21] D. M. Aukes, B. Heyneman, J. Ulmen, H. Stuart, M. R. Cutkosky, S. Kim, P. Garcia, and A. Edsinger, “Design and testing of a selectively compliant underactuated hand,” The International Journal of Robotics Research, vol. 33, no. 5, pp. 721-735, 2014.
[22] S. B. Diller, S. H. Collins, and C. Majidi, “The effects of electroadhesive clutch design parameters on performance characteristics,” Journal of Intelligent Material Systems and Structures, vol. 29, no. 19, pp. 3804-3828, 2018.
[23] K. Zhang, E. J. Gonzalez, J. Guo, and S. Follmer, “Design and analysis of high-resolution electrostatic adhesive brakes towards static refreshable 2.5 D tactile shape display,” IEEE transactions on haptics, vol. 12, no. 4, pp. 470-482, 2019.
[24] R. Hinchet and H. Shea, “High force density textile electrostatic clutch,” Advanced Materials Technologies, vol. 5, no. 4, p. 1900895, 2020.
[25] V. Ramachandran, J. Shintake, and D. Florcano, “All-fabric wearable electroadhesive clutch,” Advanced Materials Technologies, vol. 4, no. 2, p. 1800313, 2019.
[26] V. Ramachandran, F. Schilling, A. R. Wu, and D. Floreano, “Smart textiles that teach: Fabric-based haptic device improves the rate of motor learning,” Advanced Intelligent Systems, vol. 3, no. 11, p. 2100043, 2021.
[27] A. Detailleur, S. Umans, H. Van Even, A. Pennycott, and H. Vallery, “Feasibility analysis of a self-reinforcing electroadhesive rotational clutch,” in 2021 IEEE/ASME International Conference on Advanced Intelligent Mechatronics (AIM), pp. 478-483, IEEE, 2021.
[28] O. Testoni, A. Bergamini, S. Bodkhe, and P. Ermanni, “A novel concept for adaptive friction damper based on electrostatic adhesion,” Smart Materials and Structures, vol. 29, no. 10, p. 105032, 2020.
[29] T. Nakamura and A. Yamamoto, “Modeling and control of electroadhesion force in dc voltage,” Robomech. Journal, vol. 4, no. 1, pp. 1-10, 2017.
[30] R. Chen, Z. Zhang, R. Song, C. Fang, D. Sindersberger, G. J. Monkman, and J. Guo, “Time-dependent electroadhesive force degradation,” Smart Materials and Structures, vol. 29, no. 5, p. 055009, 2020.
[31] M. Graule, P. Chirarattananon, S. Fuller, N. Jafferis, K. Ma, M. Spenko, R. Kornbluh, and R. Wood, “Perching and takeoff of a robotic insect on overhangs using switchable electrostatic adhesion,” Science, vol. 352, no. 6288, pp. 978-982, 2016.
[32] N. Fcizi, S. F. Atashzar, M. R. Kermani, and R. V. Patel, “Design and modeling of a smart torque-adjustable rotary electroadhesive clutch for application in human-robot interaction (currently under the second round of review. ID: TMECH-09-2021-12499.R1),” IEEE/ASME Transactions on Mechatronics.
[33] L. Marchal-Crespo and D. J. Reinkensmeyer, “Review of control strategies for robotic movement training after neurologic injury,” Journal of neuroengineering and rehabilitation, vol. 6, no. 1, pp. 1-15, 2009.
[34] C. Weiller, M. Juptner, S. Fellows, M. Rijntjes, G. Leonhardt, S. Kiebel,” S. Muller, H. Diener, and A. Thilmann, “Brain representation of active” and passive movements,” Neuroimage, vol. 4, no. 2, pp. 105-110, 1996.
[35] M. R. Kermani, R. V. Patel, and M. Moallem, “Friction identification and compensation in robotic manipulators,” IEEE Transactions on Instrumentation and Measurement, vol. 56, no. 6, pp. 2346-2353, 2007.
   [36] Mark W. Spong, Seth Hutchinson, and M. Vidyasagar, “Multivariable control,” in Robot Modeling and Control, pp. 263-279, JOHN WILEY & SONS, INC., 2006.
[37] Bruno Siciliano, Lorenzo Sciavicco, Luigi Villani, Giuseppe Oriolo, Robotics: Modelling, Planning and Control. London, England: Springer, 2009.
[38] K. Ogata, Modern Control Engineering, vol. 5. Prentice hall Upper Saddle River, NJ, 2010.
[39] M. A. Tavallaci, S. F. Atashzar, and M. Drangova, “Robust motion control of ultrasonic motors under temperature disturbance,” IEEE Transactions on Industrial Electronics, vol. 63, no. 4, pp. 2360-2368, 2015.
[40] A. Basteris, S. M. Nijenhuis, A. H. Stienen, J. H. Buurke, G. B. Prange, and F. Amirabdollahian, “Training modalities in robot-mediated upper limb rehabilitation in stroke: a framework for classification based on a systematic review,” Journal of neuroengineering and rehabilitation, vol. 11, no. 1, pp. 1-15, 2014.
[41] Z. Rajestari, N. Feizi, and S. Taghvaci, “Kinematic synthesis and optimization of continuous passive motion mechanisms for kncc,” in 2017 7th International Conference on Modeling, Simulation, and Applied Optimization (ICMSAO), pp. 1-6, IEEE, 2017.

### Experimental Exemplification: Experimental Example 3

I. INTRODUCTION. Human-centered robotic systems have attracted a great deal of interest in various industries, including in the medical domain and in automotive factories. Such robots share a large workspace with humans; thus, their inherent safety is of paramount importance [1]-[5]. In order to satisfy the safety requirements, several software techniques are proposed in the literature, including passivity-based stabilizers besides, fault detection, and fault-tolerant control [6]. Despite the benefit of software safety, it is always required to have a mechanical safety layer to avoid safety violations in case a dangerous event is not detected or avoided due to software glitches. Mechanical safety features are typically achieved through decoupling high impedance actuators from the end effector or employing semi-passive actuators that provide inherent safety in the system [7].

Magneto-rheological (MR) and Electro-rheological (ER) clutches are two of the common semi-passive actuators that have been widely used in human-robot interaction (HRI) systems [8], [9]. Both of these systems generate a tunable mechanical coupling between the actuator and the end effector through viscous friction. In an MR clutch, the transferred torque (or transferred force in a linear design) can be controlled by varying the magnetic field around the smart MR fluid inside the clutch. Despite the significant performance improvement in terms of torque density that achieved using permanent magnets and squeeze mode design [11], MR clutches are heavy and high-power consumers due to the need for a coil to generate a magnetic field. The transferred torque of an ER clutch is controlled by varying the electric field applied to the driving ER fluid [9]. This eliminates the need for a coil; however, the naturally low viscosity of the ER fluid limits the transferred torque of the clutch. The above-mentioned issues limit the application of ER and MR clutches in mobile and/or wearable HRI systems [12].

Electroadhesion (EA) actuators provide a higher force density when compared with the ER- and MR-based actuators. EA has been used mostly for pick and place applications and wall climbing robots [13], [14]. The proper selection of dielectric and substrate materials results in very high adhesion with low energy consumption. The friction force due to this adhesion has been used as an ON/OFF locking mechanism. In [15], and [16], linear EA clutches have been used to develop wearable tactile devices. A lightweight, low-power linear EA clutch is used in for an ankle exoskeleton. The same group also investigated the effect of the design parameters on EA [18]. Electroadhesion is used to lock the revolute joints of a robotic hand and the prismatic joints of a tactile display [20].

One of the main challenges with EA is the space charge buildup in the dielectric over time that counteracts the primary electric field. This causes EA degradation when the clutch is active [21], and slows down de-adhesion (residual adhesion) after deactivation [23], [24]. Reversing polarity and resonant vibration of the disc by using alternating current (AC) at the onset of deactivation are proposed in the literature for rapid EA release to eliminate residual adhesion due to space charges. EA degradation has not been well investigated in the literature. This is mainly because EA was only used in ON/OFF applications (mostly for a short time) which allows the separated space charges to vanish over the inactive session.

II. DESIGN. The electroadhesion between two conductors is formed based on the parallel plate capacitor force, following Coulomb's law. The attraction stress between two parallel conductor plates (electrodes) separated by a dielectric is given by

$${σ}_{sh} ( V ) = \frac{{ϵ}_{r} {ϵ}_{0} {V}^{2}}{2 {h}^{2}} \qquad ( 1 )$$

where ϵᵣ is the relative permittivity of the insulator, ϵ_{D} is the permittivity of vacuum, V is the applied voltage across the plates, and h is the distance between the plates.

In (1), the effect of charge buildup in the dielectric, which leads to adhesion degradation, is neglected. The charge buildup with a direct current (DC) signal can be formulated with an exponential decay function [21], thus, leading to the step response of the resultant shear stress as follows:

$${σ}_{sh}^{DC} ( t , V ) = {σ}_{sh} ( V ) - {σ}_{sh} ( V ) ( 1 - {e}^{- t / {τ}_{d}} ) \qquad ( 2 )$$

where τ_{d} is the time constant of the degradation function. The first term in (2) represents stress due to the primary electric field, and the second term represents the adhesion degradation due to charge buildup.

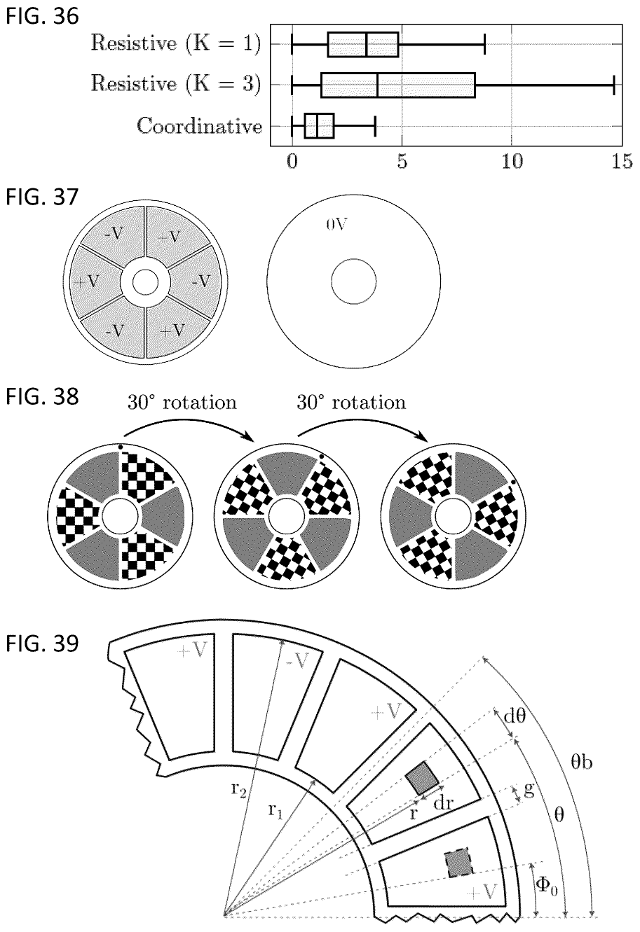

A. Segmented Electrode Design (SED) Concept. By modulating the electric field using the SED design, the direction of the electric field gradually flips with the rotation of the rotor. The gradual change of the electric field prevents EA degradation. To do so, both positive and negative electrodes are placed on one of the discs (we selected the stator disc in this paper), which is not covered with the dielectric. The conductor part of the stator disc is segmented into smaller parts with a uniform gap between them. Every other segment of the stator disc is connected together, creating two classes of segments. One class is charged positive, and the other one is charged negative, as shown in FIG. 37. Therefore, segments having positive charge are electrically communicative and segments having negative charge are electrically communicative, while the segments having positive charge are electrically isolated from the segments having negative charge. The rotor disc, which slides against the stator disc, is made of a uniform conductor covered with dielectric and has relative voltage potential of zero.

Putting the stator disc and the rotor disc against each other leads to the electric field, as shown in FIG. 38, over the dielectric (the gray color denotes the electric field going into the plane and the checkerboard pattern denotes the electric field coming out of the plane). As can be seen, with relative rotation of the discs, the direction of the electric field over the dielectric flips. This gradual change in the dielectric field prevents residual charge buildup in the field without the need for alternating the voltage across the electrodes.

A. Optimal design. Increasing the modulation frequency of the electric field by increasing the number of segments results in less EA degradation and, therefore, higher torque. However, the number of gaps between segments also increases with the increase of the number of segments. Therefore, the effective area of the discs, which only includes the area of the electrodes, and thus the maximum output torque, reduces. Reducing gap width increases the effective area of the disc, but it also limits the applied voltage across the electrodes due to electric discharge between two adjacent positive and negative electrodes. This trade-off demonstrates the need for the optimal design of the number of segments.

In order to find the optimal design to achieve the maximum torque, the equation of the torque should be calculated. By considering an infinitesimal portion of the dielectric on the rotor disc with radius r and angular position θ in polar coordinate, as shown in FIG. 39, and integrating the torque over the friction area, the equation for the maximum achievable torque is obtained as follows:

$$T ( t ) = {\int }_{0}^{2 π} {\int }_{{r}_{1}}^{{r}_{2}} r {C}_{f} {dF}_{n} \qquad ( 3 )$$

where r₁ and r₂ are the inner and outer radii of the friction ring, C_{f} is the friction coefficient, and dFₙ is the normal force applied to the infinitesimal piece due to adhesion which is given by

$${dF}_{n} = {E}^{2} {ϵ}_{0} {ϵ}_{r} r dr d θ \qquad ( 4 )$$

where E is the resultant electric field associated with the infinitesimal piece, ϵ_{D} is the permittivity of vacuum, ϵᵣ is the relative permittivity of the dielectric, and the resultant electric field E over the dielectric is given by

$$E = {E}_{p} + {E}_{s} \qquad ( 5 )$$

where Eₚ is the primary electric field given by

$${E}_{p} = \frac{V ( θ , r , v )}{h} \qquad ( 6 )$$

and Eₛ is the electric field due to the space charge buildup. According to the step response mentioned in (2), Es is formulated by the differential equation below:

$${\dot{E}}_{s} + \frac{{E}_{s}}{{τ}_{d}} + \frac{V ( θ , r , v )}{{τ}_{d} h} = 0 \qquad ( 7 )$$

where τ_{d} is the time constant of the electric field degradation, h is the thickness of the dielectric, and V is the voltage difference across the two electrodes over the dielectric piece. Voltage for a point with radius r and angle θ for the geometry of the proposed SED is determined as follows:

$$V ( θ , r , v ) - \{ \begin{matrix}0 & {θ}_{1} ( r ) > {θ}_{i} \geq 0 \\ v & {θ}_{2} ( r ) > {θ}_{i} \geq {θ}_{1} ( r ) \\ 0 & {θ}_{3} ( r ) > {θ}_{i} \geq {θ}_{2} ( r ) \\ - v & {θ}_{4} ( r ) > {θ}_{i} \geq {θ}_{3} ( r ) \\ 0 & {θ}_{b} > {θ}_{i} \geq {θ}_{4} ( r )\end{matrix} \qquad ( 8 )$$

$$where$$

$${θ}_{i} ≡ θ mod {θ}_{b} \qquad ( 9 )$$

in that θ_{b} is the associated angle for a block including a pair of electrodes which is equal to

$$\frac{720}{N}$$

where N is the number of segments and is an even number; θ is the absolute angle of the infinitesimal piece, which is given by

$$θ = {\int }_{0}^{t} ω ( t ) + {ϕ}_{0} \qquad ( 10 )$$

where ω is the relative rotational velocity of the rotor disc with respect to the stator disc at time t, and φ₀ is the initial angle of the piece; θ₁(r) to θ₄(r) represent the boundary of a pair of electrodes for radius r and are given by

$$\begin{matrix}{θ}_{1} ( r ) = f ( g , r ) , & {θ}_{2} ( r ) = \frac{{θ}_{b}}{2} - f ( g , r )\end{matrix} \qquad ( 11 a )$$

$$\begin{matrix}{θ}_{3} ( r ) = \frac{{θ}_{b}}{2} + f ( g , r ) , & {θ}_{4} ( r ) = {θ}_{b} - f ( g , r )\end{matrix} \qquad ( 11 b )$$

$$where$$

$$f ( g , r ) = {sin}^{- 1} ( \frac{g}{2 r} ) \qquad ( 12 )$$

and g is the width of the gap between the electrodes.

The electric field given by the analytical model (5) was numerically calculated over the whole friction area for a 6segment rotor using MATLAB. In this simulation, the voltage difference between the electrodes was 400 V, which resulted in 200 V between the electrode and the rotor disc. The simulation parameters are shown in Table 7. FIG. 40 shows the resultant electric field at the onset of activation of the clutch (left figure) and after 10 seconds of activation when the rotor rotates with 2 RPM (right figure). As seen, the electric field degrades gradually from head to tail of each segment after a passage of time. However, the modulation of the electric field when a segment with an opposite charge slides against a part of the dielectric with accumulated space charge increases the resultant electric field to the maximum.

TABLE 7
Simulation parameters.

| parameter | value | parameter | value | parameter | value |
|---|---|---|---|---|---|
| τ_{d} | 10 s | εᵣ | 32 | r₁ | 4 mm |
| C_{f} | 0.28 | d | 95 μm | r₂ | 6 mm |

The electric field degradation time constant Ta was selected based on measurements in the preliminary experiments. The friction coefficient Cf was selected based on the experimental measurement of the friction of dielectric against steel. The dielectric thickness is selected to be 95 μm, which is thicker than the optimal value reported in [18]. A thicker dielectric layer increases the lifespan of the clutch due to wear and also provides stronger electric isolation between the discs. According to the air breakdown electric field threshold (3 kV/mm), the air gap between two adjacent electrodes should be larger than 0.33 mm to avoid electric discharge between the two adjacent electrodes with a 1 kV voltage difference (the maximum applicable voltage limited by the electronics). However, the preliminary experiments have shown that a large safety factor should be considered in the design since the accumulation of the debris in the gap between electrodes causes electric discharge at a much lower voltage than expected. Thus, the gap between electrodes was selected to be 2 mm to allow accumulation of the debris without electric discharge.

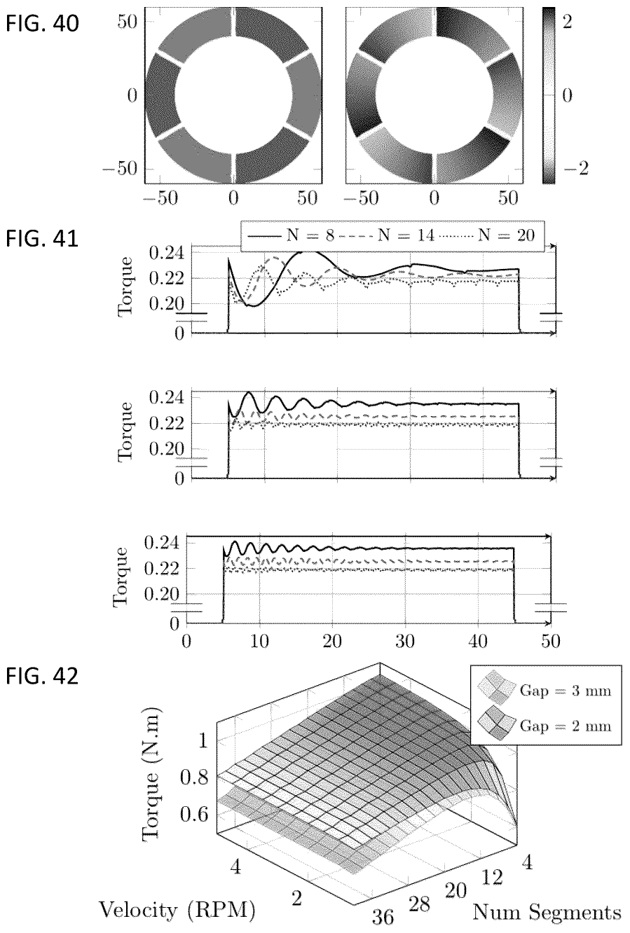

The maximum output torque of the clutch formulated in (3) when the clutch is activated with a step signal is shown in FIG. 41 (results are for one friction ring). The transition of the electric field from uniform to decayed, as shown in FIG. 40, has led to an under-damped behavior of the torque. As seen, the number of segments and the velocity of rotation has a direct effect on the frequency of oscillation of the torque.

The design velocity range of the clutch was selected to be 0.5 RPM to 15 RPM. The average of the maximum achievable torque for a number of segments ranging from 4 to 40 is calculated using (3). The results are shown in

FIG. 42. A smaller number of segments leads to higher torque when the velocity is high, which is because of the larger friction area. Since the effect of the number of segments on the torque for low velocities is remarkably higher than for a high velocity, the optimal number of segments was selected to be 14, which is the optimal value for when the velocity is 0.5 RPM. In order to demonstrate the effect of gap width, the same result for when the gap width is 3 mm is also included. As seen, the torque reduces with the increase of gap width.

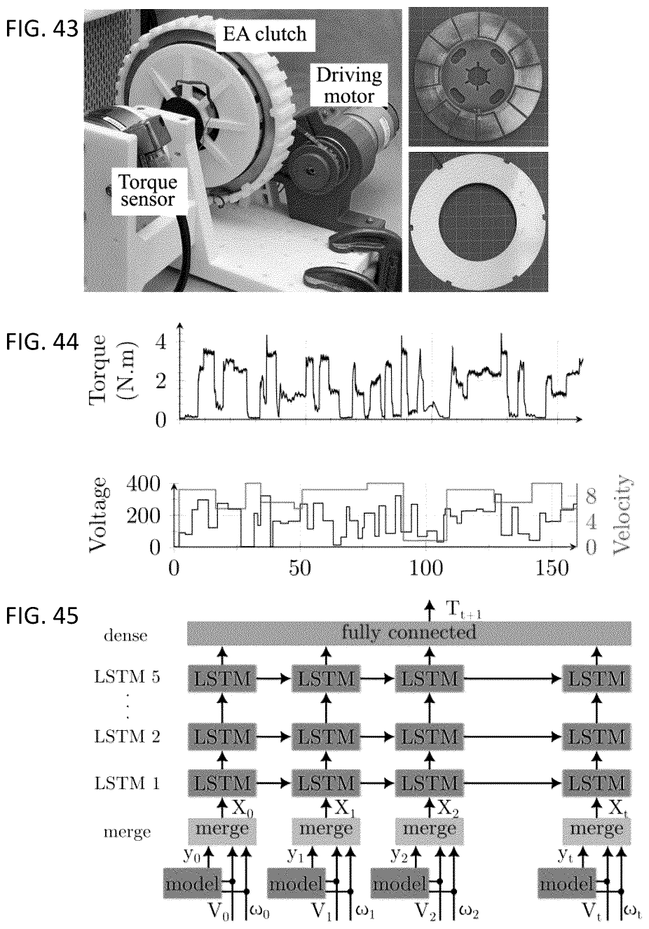

III. FABRICATION. The rotor disc was made of a 0.1 mm thick 1059 Spring steel sheet covered with five layers (95 μm thick) of Dupont 8153 dielectric. The sheet was cut to shape using electric discharge machining, as shown in FIG. 43. The inner diameter of the rotor disc was selected to be 8 cm.

The stator disc was made of a 2-layer circular printed circuit board (PCB) with an outer diameter of 12 cm. Every other electrode on the disc is connected together, and the electrodes on each side of the disc are connected to the associate electrode on the other side of the disc. Therefore, segments having positive charge are electrically communicative and segments having negative charge are electrically communicative, while the segments having positive charge are electrically isolated from the segments having negative charge. A constant gap of 2 mm was maintained between adjacent electrodes. However, the gap was reduced to 1.2 mm out of the friction area to discharge the electrodes without damaging the dielectric in case of an unexpected high voltage. In order to increase the friction area, one stator disc is sandwiched between two rotor discs.

A custom PCB was made to activate the clutch. A 1 kV MHV 12 DC-DC high voltage transformer (Bellnix Co., Saitama, Japan) was used to provide the required voltage. An MCP4821 digital-to-analogue converter chip (Microchip Technology, AZ, US) was used to adjust the output voltage of the transformer, and Arduino was used to interface the driver circuit to QuaRC software in the MATLAB Simulink environment through serial communication.

IV. DATA-DRIVEN MODEL. The analytical model proposed in Section II covered the general dynamic behavior of the clutch and was used to optimize the design of the segmented clutch. However, the accuracy of the torque estimation of the analytical model is compromised by the unmodeled nonlinear dynamic of the clutch. In this section, a fusion of the proposed analytical model with an LSTM network is proposed, resulting in a hybrid data-driven approach to significantly boost the accuracy of the clutch model, taking advantage of the power of the LSTM in modeling dynamical behavior through learning while also taking into account the known part of the dynamics through analytical modeling.

The analytical part of the model can provide robustness in case the collected data does not train the full analytical behavior of the system. In addition, the LSTM would allow covering complex temporal behavior such as the hysteresis of the system using the internal memory components. LSTM has been used in the literature to model the dynamics of other complex actuators [26]-[28]. Each LSTM layer is consisted of forgetting, update, and output gates that learn to adjust the flow of information from the past hidden state to the future state and pass the relevant information downstream [29]. The equations of an LSTM block are as follows:

$${a}^{< t >} = {Γ}_{0} * tanh ( {c}^{< t >} ) \qquad ( 13 a )$$

$${c}^{< t >} = {Γ}_{u} * {c}^{< t >} + {Γ}_{f} * {c}^{< t - 1 >} \qquad ( 13 b )$$

$${c}^{< t >} = tanh ( {w}_{c} [ {a}^{< t - 1 >} , {X}^{< t >} ] + {b}_{c} ) \qquad ( 13 c )$$

$${Γ}_{u} = σ ( {w}_{u} [ {a}^{< t - 1 >} , {X}^{< t >} ] + {b}_{u} ) \qquad ( 13 d )$$

$${Γ}_{f} = σ ( {w}_{f} [ {a}^{< t - 1 >} , {X}^{< t >} ] + {b}_{f} ) \qquad ( 13 e )$$

$${Γ}_{o} = σ ( {w}_{o} [ {a}^{< t - 1 >} , {X}^{< t >} ] + {b}_{o} ) \qquad ( 13 f )$$

where Γᵤ, Γ_{f}, and Γₒ denote the update gate, the forgetting gate, and the output gate, respectively; a is the output of the previous block; wₓ and bₓ are the trainable weights and biases for the associated gate; and X is the input time sequence.

A. Data Collection. In order to train the network, a 30-minute sequence of velocity, voltage, and torque data was recorded with a sampling frequency of 100 Hz. During the data collection procedure, the rotor of the clutch was rotated with a random velocity from 1 to 10 RPM and for a random duration. The clutch was activated with a random amplitude of 0 to 350 V and for a random duration. FIG. 44 shows a sample of the training data.

B. Network Structure. A many-to-one network made of 5 LSTM layers with 100 nodes for each layer and one fully-connected (dense) layer was used. The analytical model estimation y was merged with the input signals (voltage V and velocity @) before the LSTM network, as shown in FIG. 45.

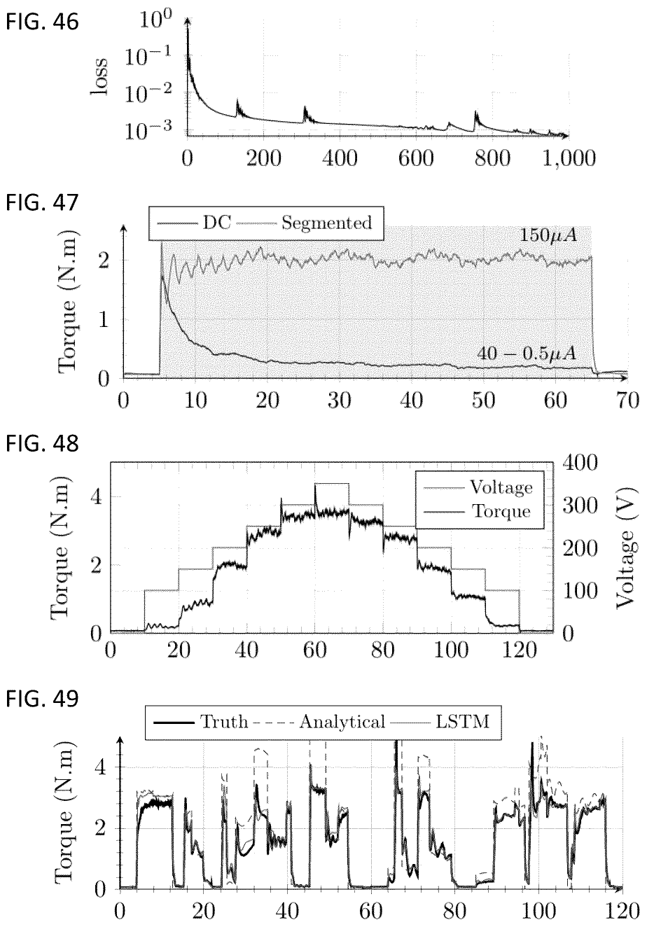

The mean square error (MSE) was used to calculate the loss between prediction and ground truth. Adam optimization was used to update the weights of the network (learning rate=0.005). The learning rate, the number of hidden layers, the number of nodes per layer, and the location of the merged layer were manually tuned through observation of the effect of each parameter in minimizing the training loss. The model was implemented using the TensorFlow open-source library in Python and was trained for 1000 epochs. The MSE for the training data was determined to be 6.7×10-4 N·m. FIG. 46 shows the training loss.

V. RESULTS AND DISCUSSION. FIG. 47 shows the results when the clutch was activated with conventional DC and the proposed segmented DC method. In both experiments, the same rotor and stator disc were used to allow comparison of the three modes. In the conventional DC mode, all segments of the stator disc were connected together, and the clutch was activated with 200 V. In the segmented DC mode, 200 V was applied between each segment and rotor disc (400 V across adjacent segments). The numbers close to each graph in FIG. 47 show the electric current used during each experiment. In all experiments, the rotor was rotated at 5 RPM.

As can be seen, the torque degrades significantly with time for DC activation. However, the proposed SED results in maintaining a torque much more than the DC mode. By comparing the experimental results with the analytical model presented in Section II, it can be seen that the under-damped behavior in the experiment complies with the analytical model results shown in FIG. 41. This behavior is due to the transition of the uniform electric field to the modulated electric field, as shown in FIG. 38.

FIG. 48 shows the output torque for a stairs input signal with the amplitude of 100 to 350 V. As can be seen, the average torque nonlinearly increases with the increase of the input voltage. An under-damped behavior can also be seen for low voltages; however, it damps out after a while for high voltages. We cannot provide a reasonable explanation for the vanish of the under-damped behavior with time. In addition, spikes can be seen in the torque signal at the onset of change of the signal in high voltages. This is mainly because of the instantaneous static friction between the discs (which is more than sliding friction) when the voltage and, consequently, the friction are high. It was observed that the width of the spikes reduces with the increase of velocity, and also, the dynamics of torque change with the change of velocity. These variations with torque with velocity are because of the inherent dependency of the electric field on velocity and also the variation in friction with change in velocity. Thus, other nonlinear dynamics are evolved in the system, which are not considered in the model.

FIG. 49 shows the analytical model, the hybrid LSTM network predictions, and the ground truth value for 2 minutes of the testing dataset. The testing dataset was recorded when the clutch was rotated with a random velocity, and the clutch was activated with step signals with random amplitude and random duration, similar to the training dataset. As can be seen, the analytical model predicts the general behavior of the clutch; however, the prediction is not accurate due to the above-mentioned unmodeled nonlinear dynamics.

The proposed hybrid LSTM model is effective in modeling the nonlinear dynamics of the clutch and accurately predicts the output torque using fused information from the analytical model and clutch inputs. Mean square error and mean absolute error for the test data (4 minutes of new data) were determined to be 2.3×10-4 N·m and 1.1×10-2 N·m, respectively. The proposed hybrid LSTM model also predicts the spikes in the torque due to the instantaneous static friction.

VI. CONCLUSION. A novel rotary electroadhesive clutch based on segmented electrodes was modeled, designed, and implemented. An analytical model was developed and used in the design optimization. An experimental study was conducted to validate the performance of the proposed segmented design in preventing electroadhesion degradation with time as well as residual adhesion. With the proposed design, a robust torque was achieved for direct current activation signals. A data-driven model augmentation using a hybrid shallow learning approach based on the fusion of the analytical model and an LSTM network was developed. The proposed design for a torque-tunable electroadhesive clutch, along with the data-driven hybrid dynamic model, shows great potential for mobile and wearable HRI systems due to accuracy, high torque density, and low power. Future research will utilize the developed hybrid model in the implementation of an adaptive torque control scheme for application in HRI system.

### VII. Reference List for Experimental Example 2

[1] N. Feizi, M. Tavakoli, R. V. Patel, and S. F. Atashzar, “Robotics and ai for teleoperation, tele-assessment, and tele-training for surgery in the era of covid-19: Existing challenges, and future vision,” Frontiers in Robotics and AI, vol. 8, p. 610677, 2021.
[2] I. D'iaz, J. J. Gil, and E. Sanchez, “Lower-limb robotic rehabilitation:’ literature review and challenges,” Journal of Robotics, vol. 2011, 2011.
[3] P. Maciejasz, J. Eschweiler, K. Gerlach-Hahn, A. Jansen-Troy, and S. Leonhardt, “A survey on robotic devices for upper limb rehabilitation,” Journal of Neuroengineering and Rehabilitation, vol. 11, no. 1, pp. 1-29, 2014.
[4] A. Mohebbi, “Human-robot interaction in rehabilitation and assistance: a review,” Current Robotics Reports, vol. 1, no. 3, pp. 131-144, 2020.
[5] T. B. Sheridan, “Human-robot interaction: status and challenges,” Human factors, vol. 58, no. 4, pp. 525-532, 2016.
[6] S. F. Atashzar, M. Shahbazi, M. Tavakoli, and R. V. Patel, “A graspbased passivity signature for haptics-enabled human-robot interaction: Application to design of a new safety mechanism for robotic rehabilitation,” International Journal of Robotics Research, vol. 36, no. 5-7, pp. 778-799, 2017.
[7] A. S. Shafer and M. R. Kermani, “On the feasibility and suitability of mr fluid clutches in human-friendly manipulators,” IEEE/ASME Transactions on Mechatronics, vol. 16, no. 6, pp. 1073-1082, 2010.
[8] N. Najmaci, A. Asadian, M. R. Kermani, and R. V. Patel, “Design and performance evaluation of a prototype mrf-based haptic interface for medical applications,” IEEE/ASME Transactions on Mechatronics, vol. 21, no. 1, pp. 110-121, 2015.
[9] J. R. Davidson and H. I. Krebs, “An electrorheological fluid actuator for rehabilitation robotics,” IEEE/ASME Transactions on Mechatronics, vol. 23, no. 5, pp. 2156-2167, 2018.
[10] S. Pisetskiy and M. Kermani, “High-performance magneto-rheological clutches for direct-drive actuation: Design and development,” Journal of Intelligent Material Systems and Structures, vol. 32, no. 20, pp. 2582-2600, 2021.
[11] S. Pisetskiy and M. R. Kermani, “A concept of a miniaturized mr clutch utilizing mr fluid in squeeze mode,” in 2020 IEEE/RSJ International Conference on Intelligent Robots and Systems (IROS), pp. 6347-6352, 2020.
[12] L. Roveda, L. Savani, S. Arlati, T. Dinon, G. Legnani, and L. M. Tosatti, “Design methodology of an active back-support exoskeleton with adaptable backbone-based kinematics,” International Journal of Industrial Ergonomics, vol. 79, p. 102991, 2020.
[13] J. Guo, J. Leng, and J. Rossiter, “Electroadhesion technologies for robotics: A comprehensive review,” IEEE Transactions on Robotics, vol. 36, no. 2, pp. 313-327, 2019.
[14] E. W. Schaler, D. Ruffatto, P. Glick, V. White, and A. Parness, “An electrostatic gripper for flexible objects,” in 2017 IEEE/RSJ International Conference on Intelligent Robots and Systems (IROS), pp. 1172-1179, 2017.
[15] R. Hinchet and H. Shea, “High force density textile electrostatic clutch,” Advanced Materials Technologies, vol. 5, no. 4, p. 1900895, 2020.
[16] V. Ramachandran, J. Shintake, and D. Florecano, “All-fabric wearable electroadhesive clutch,” Advanced Materials Technologies, vol. 4, no. 2, p. 1800313, 2019.
[17] S. Diller, C. Majidi, and S. H. Collins, “A lightweight, low-power electroadhesive clutch and spring for exoskeleton actuation,” in 2016 IEEE International Conference on Robotics and Automation (ICRA), pp. 682 689, 2016.
[18] S. B. Diller, S. H. Collins, and C. Majidi, “The effects of electroadhesive clutch design parameters on performance characteristics,” Journal of Intelligent Material Systems and Structures, vol. 29, no. 19, pp. 3804-3828, 2018.
[19] D. M. Aukes, B. Heyneman, J. Ulmen, H. Stuart, M. R. Cutkosky, S. Kim, P. Garcia, and A. Edsinger, “Design and testing of a selectively compliant underactuated hand,” International Journal of Robotics Research, vol. 33, no. 5, pp. 721-735, 2014.
[20] K. Zhang, E. J. Gonzalez, J. Guo, and S. Follmer, “Design and analysis of high-resolution electrostatic adhesive brakes towards static refreshable 2.5 d tactile shape display,” IEEE Transactions on Haptics, vol. 12, no. 4, pp. 470-482, 2019.
[21] R. Chen, Z. Zhang, R. Song, C. Fang, D. Sindersberger, G. J. Monkman, and J. Guo, “Timc-dependent electroadhesive force degradation,” Smart Materials and Structures, vol. 29, no. 5, p. 055009, 2020.
[22] T. Nakamura and A. Yamamoto, “Modeling and control of electroadhesion force in dc voltage,” Robomech Journal, vol. 4, no. 1, pp. 1-10, 2017.
[23] J. Singh, P. A. Bingham, J. Penders, and D. Manby, “Effects of residual charge on the performance of electro-adhesive grippers,” in Annual Conference Towards Autonomous Robotic Systems, pp. 327-338, 2016.
[24] W. Kalus, Ł. Nagi, and J. Zygarlicki, “Analysis of potential of raising forces acting on electroadhesive pads depending on polarization and supply parameters,” Energies, vol. 14, no. 9, p. 2517, 2021.
[25] X. Gao, C. Cao, J. Guo, and A. Conn, “Elastic electroadhesion with rapid release by integrated resonant vibration,” Advanced Materials Technologies, vol. 4, no. 1, p. 1800378, 2019.
[26] H. Xiao, J. Wu, W. Ye, and Y. Wang, “Dynamic modeling for dielectric elastomer actuators based on 1stm deep neural network,” in 2020 5th International Conference on Advanced Robotics and Mechatronics (ICARM), pp. 119-124, 2020.
[27] M. T. Gillespie, C. M. Best, E. C. Townsend, D. Wingate, and M. D. Killpack, “Learning nonlinear dynamic models of soft robots for model predictive control with neural networks,” in 2018 IEEE International Conference on Soft Robotics (RoboSoft), pp. 39-45, 2018.
[28] T. Luong, K. Kim, S. Seo, J. Jeon, C. Park, M. Doh, J. C. Koo, H. R. Choi, and H. Moon, “Long short term memory model based position stiffness control of antagonistically driven twisted-coiled polymer actuators using model predictive control,” IEEE Robotics and Automation Letters, vol. 6, no. 2, pp. 4141-4148, 2021.
[29] S. Hochreiter and J. Schmidhuber, “Long short-term memory,” Neural Computation, vol. 9, no. 8, pp. 1735-1780, 1997.

Several illustrative variants of electroadhesion control of rotary motion have been described above. Further variants and modifications are described below. Moreover, guiding relationships for configuring variants and modifications are also described below. Still further variants and modifications are contemplated and will be recognized by the person of skill in the art. It is to be understood that guiding relationships and illustrative variants or modifications are provided for the purpose of enhancing the understanding of the person of skill in the art and are not intended as limiting statements.

For example, the shape and size of plates can vary. In the drawings, the first, second and third plates are shown to be formed in a circular shape for illustrative purposes only, and the shape is not limited to circular and may be any other desired shape such as square or triangular. The size of plates, such as dimensions of diameter, circumference or thickness may also be varied as may be suited for a particular implementation.

As another example of variation, plate configurations are not limited to a single contact pair as shown in FIG. 1 or a single contact triplet as shown in FIG. 19, and may include a plurality of contact pairs or a plurality of contact triplets or a combination of a contact pair and a contact triplet. When a pressure plate is incorporated, each contact pair or each contact triplet may be accompanied by a dedicated pressure plate, or a single pressure plate may bias a manifold that connects to and biases plates together in a plurality of contact pairs or contact triplets.

As another example of variation, a dry sliding friction between plates in absence of electroadhesion may be zero, or close to zero, or any predetermined acceptable minimal amount. In the Experimental Examples, the dry sliding friction is close to zero, but slightly greater than zero, to achieve a balance between the size of the gap at the electroadhesion interface and the dry sliding friction between the contact surfaces, so as to minimize the gap at the electroadhesion interface in absence of the applied electric field, while maintaining dry sliding friction at a sufficiently reduced magnitude to not result in motion of a load connected to the output shaft.

Two competing goals occur in the design of interacting plates and their electroadhesion interface at interacting contacts surfaces: (1) maximize transfer of torque from a driver plate to a driven plate when the electric field is applied to activate electroadhesion interaction. (2) minimize transferred torque when the electric field is absent to deactivate electroadhesion interaction.

In an illustrative scenario to achieve the first goal, there should be no gap between the interacting plates (driver plate and driven plate) in the design. In this case, the plates are always touching, thus the clutch is ready to activate once the activation voltage is applied. In this scenario, 100 percent of the electroadhesion force between the plates will be used to build friction between the plates and transfer the torque. However, manufacturing this clutch with zero gap between the plates requires high-precision machining, which may not be cost-effective and potentially may cause significant dry friction when the clutch is inactive. This friction is not due to electroadhesion, but rather because of the zero gap between two rigid plates. Therefore, this scenario violates the goal of zero torque when the clutch is not active.

In an illustrative scenario to fulfill the second goal (zero torque when the clutch is not active), a small gap is maintained between the plates in the design to ensure absolutely zero friction between the plates in absence of an applied electric field. However, if plates are rigid with a gap between them, a significant portion of the electroadhesion will be wasted in bending the discs to eliminate the gap (this process also adds a delay in the reaction of the clutch), and the remaining electroadhesion will be directed towards generating friction between the plates. In this scenario, when the clutch is off, the discs separate due to the spring-back effect, and the torque reduces to zero when the clutch is deactivated. However, in this scenario the maximum possible torque cannot be achieved when the clutch is 100% activated.

One example of a solution to the aforementioned two competing goals is presented in the Experimental Examples, with one plate sliding in an axial direction (the direction perpendicular to the plate circumference plane and parallel to the axis of rotation) biased by a pressure plate to minimize a gap between interacting plates. Although a sliding plate is positionally-moveable, a constant pressure exerted by a pressure plate maintains the sliding plate as positionally-fixed throughout activation/deactivation cycles of the electroadhesion interface.

As another example of a solution to the aforementioned two competing goals, at least one of the plates is flexible in the axial direction (the direction perpendicular to the plate circumference plane and parallel to the axis of rotation) and a small gap is introduced between the plates. A pressure disc biases (gently pushes) the plates together and minimizes the gap between plates (for example, reduces the gap to zero without relying on electroadhesion). Although a flexible plate is positionally-moveable by bending, a constant pressure exerted by a pressure plate maintains the flexible plate as positionally-fixed throughout activation/deactivation cycles of the electroadhesion interface. With this design, even when the clutch is off, there is no gap between the plates, so the clutch is ready to be activated immediately without the waste of electroadhesion to bend the plate(s) and make the gap zero. Thus, the clutch can transfer the maximum applicable torque (the first goal). Also, because the gap between the plates is not initially zero in the design, and a pressure disc easily adjusts the initial gap between the plates, the dry friction between the plates when the clutch is inactive is minimal (it was 0.05 Nm in the Experimental Examples).

The solution of bending a flexible plate has an advantage over the solution of sliding plates in simplicity of design in that a bending plate is a fixed component while a sliding plate will require a moving joint. In either solution, a pressure plate may provide a biasing force by any conventional approach such as resilient members connected to the pressure plate and one of the interacting plates including, for example, compression springs as demonstrated in the Experimental Examples, or pneumatic pistons or cylinders, or hydraulic pistons or cylinders. A resilient member can include one or more of any of the following elastic, pneumatic or gas, hydraulic spring, constant force spring motor, or other device adapted to store or exert mechanical energy, generate force and/or that is back-drivable (e.g., force applied to an output can move an input). Another example of a pressure plate biasing mechanism is achieved through magnetic components including, for example, a magnet pressure plate attracting a ferromagnetic material integrated within an interacting plate, or a magnet pressure plate either attracting or repulsing magnets attached to an interacting plate.).

In comparing an option of actuated pressure to bias interacting plates and their interacting contact surfaces together compared to an option of constant pressure to bias interacting contact surfaces together, the option of constant pressure has significant advantages in simplicity and robustness and reliability of design. The constant pressure option can be calibrated to accommodate the aforementioned two competing goals.

For practicality of operation, a minimal non-zero dry sliding friction and corresponding minimized gap at the electroadhesion interface in the absence of the applied electric field is able to more quickly actuate an increase in sliding friction and electroadhesion of contact surfaces when the electric field is applied. For practicality of operation a non-zero minimum value of dry sliding friction in absence of the applied electric field may be determined by precision of manufacture of the plates and the biasing force of the pressure plate, while a maximum value may be set to be lower than the minimum force required to move the output shaft (for example, the considered force may be due to the internal friction of driven components). Examples of minimum and maximum of dry sliding friction in absence of the applied electric field can be set as percentage of the maximum torque achieved in presence of electroadhesion upon applying the electric field. For example, torque by dry sliding friction in absence of the applied electric field may range from a minimum of 0.01% to a maximum of 1% when referenced to the maximium torque achieved in the presence of the applied electric field. Other examples, of minimum and maximum limits of torque by dry sliding friction in absence of the applied electric field may be set to suit a particular implementation, for example a minimum of 0.01% to a maximum of 2% when referenced to the maximium torque achieved in the presence of the applied electric field. Typically, a maximum of greater than 5% will not be practical and will be avoided.

Options, for applying constant pressure to bias interacting plates and their interacting contact surfaces together can include a biasing pressure to move a sliding plate or a biasing pressure to bend a flexible plate. To illustrate the options for applying constant pressure, first consider FIG. 4, which shows an electroadhesive clutch concept in the cross-section view (the term disc is used interchangeably with the term plate in this illustration). FIG. 4 shows the sliding stator disc option. In the FIG. 4 concept, the housing serves as the rotor (input), and the shaft functions as the output, connected to a downstream mechanism known as the stator. The rotor disc is designed to be rigid (high stiff); an initial airgap was introduced between the discs and the stator disc is designed to be flexible with low stiffness in the axial direction, which allows to accommodate movement and adapt to the clutch's operational needs. This unique combination of rigidity and flexibility enhances the performance and versatility of the clutch.

The concept involves a stator disc that can rotate with the shaft and slide along it using a prismatic joint between the shaft and the disc as shown in FIG. 4. This unique feature allows a pressure disc to exert a minimal force to bring the stator disc into contact with the rotor disc. To achieve this, there's a need for slight axial movement between the rotating discs and the shaft. While it's possible to make the stator disc rigid, flexibility of the disc can be advantageous. Even a slight imperfection on the friction surface can hinder uniform friction distribution across the entire friction ring. In our experiments, we opted to construct the stator disc using a thin layer (0.1 mm) of spring steel. This choice enables the discs to not only undergo axial motion to bridge the gap between the stator and rotor discs but also to flex under the pressure applied by the pressure disc and electroadhesion. This flexibility compensates for any gaps introduced between the discs due to imperfections (i.e., not being perfectly flat) on the surfaces of the rotor or the stator.

The Experimental Examples tested two distinct materials for disc fabrication in an example of constant pressure biasing a stator and rotor disc pair together: 1059 spring steel and Metalized Polyester Film (MPF). These experiments were performed to assess the material's suitability in handling an illustrative torque (˜4 N·m). The results of our experiments indicated that MPF was unsuitable for a torque of 4 Nm, primarily due to its tendency to wrinkle under the stress generated by torque. However, our tests with 0.1 mm 1059 spring steel demonstrated the desired combination of flexibility and stiffness necessary for effective torque transfer. This material proved to be well-suited for the intended purpose. Although MPF proved unsuitable for the tested torque of approximately 4 Nm, it could still be useful for implementations of lower expected torque, including for example torque less than 1 Nm, or less than 0.5 Nm. When considering various examples of contemplated implementations, an expected operational torque in various implementations could readily range from 20 Nm to 0.1 Nm.

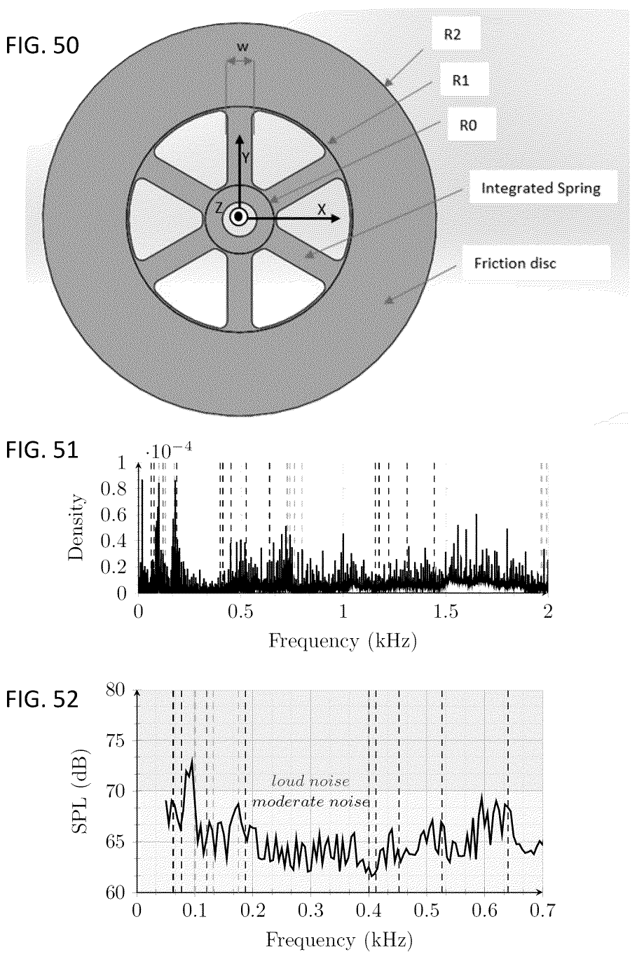

Now modifying the sliding option demonstrated in FIG. 4 to a bending option, the stator disc is fixed to the shaft and therefore, does not slide axially (i.e., the axial direction is parallel to the axis of rotation), but does bend or flex in the axial direction. More specifically, the inner circumference of the stator disc is fixed to the shaft while ensuring the stator disc exhibits sufficient flexibility in the axial direction to enable motion akin to that described for the sliding option shown in FIG. 4. Importantly, the bending option obviates the need for a prismatic joint. Simultaneously, the stator disc must possess adequate stiffness in the rotational direction to withstand the stresses induced by torque. To achieve these dual objectives, we introduce an approach involving the incorporation of leaf springs within the stator disc (see FIG. 50). These leaf springs are seamlessly integrated into the disc through strategically positioned cutouts. Modifying parameters of leaf springs including for example numbers of leaf springs, width of leaf springs, thickness of leaf springs, or length of leaf springs, allows for independent adjustment of the axial and rotational stiffness of the stator disc. Below, we present simplified mechanical equations that facilitate the calculation of the required axial force exerted by the pressure disc to bridge a gap between the stator and rotor discs in accordance with the design parameters. Additionally, we provide equations for the calculation of stress within the disc induced by torque.

Axial Stiffness (K_a) is defined as the ratio of the applied axial force, caused by a pressure disc, to the resulting axial deflection of the disc (axial direction is parallel to the axis of rotation of the interacting discs). When subjected to axial load, each leaf spring behaves like a fully supported beam, with one end bearing the load and the other end having zero bending angle. This allows us to derive the axial stiffness as described below.

$${K}_{a} = \frac{{P}_{a}}{g} = \frac{12 \times E \times {I}_{xx} \times n}{{L}^{3}}$$

g=maximum deflection of the friction disc with respect to the hub
P_a=axial force due to pressure disc
I xx:

$${I}_{xx} = \frac{1}{12} w {t}^{3}$$

moment of inertia in the width direction of the leaf spring
w-spring width
t=disc thickness
E=modulus of elasticity of the material
L=R_1−R_0 spring length
n=number of springs

Stress in the spring due to the torque:

$${σ}_{max} = \frac{M \times w}{2 \times {I}_{ZZ}}$$

$$M = \frac{T \times L}{{R}_{1} \times n}$$

moment due to torque (T) on the cross section of the leaf spring

$${I}_{ZZ} = \frac{1}{12} t {w}^{3}$$

moment of inertia in the thickness direction of the leaf spring

If we plug I_{zz} and M in

$${σ}_{max} = \frac{M \times w}{2 \times {I}_{ZZ}}$$

we have,

$${σ}_{max} = \frac{6 \times T \times L}{{R}_{1} \times n \times t \times {w}^{2}}$$

Design parameters that can be chosen are R_0, R_1, n, w, t and, g. To get the best performance, the design should be optimized to yield the minimum axial stiffness, while σ_max is below its Yield strength (σ_y) of the disc material for the maximum applicable torque.

Table 8 below shows the effect of the design parameter on the axial stiffness and stress due to torque.

TABLE 8
axial stiffness and stress related to design
parameters in the leaf spring disc.

| Design | Axial | Stress due | Direct effect |
|---|---|---|---|
| parameter | stiffness | to torque | on torque |
| R1 ↑ | ↓ | ↑ | ↓ |
| W ↑ | ↑ | ↓↓ | — |
| t ↑ | ↑↑ | ↓ | — |
| n ↑ | ↑ | ↓ | — |

Rotational Stiffness (K_θ) is defined as the ratio of the applied torque to the resulting rotational deflection of the disc. For the specific variant depicted in FIG. 50, both ends of the leaf springs are consistently perpendicular to the outer circumference of the hub and inner circumference of the friction disc. Under the influence of frictional torque, each leaf spring can be treated as a beam, with one end fully supported and the other end exhibiting zero deflection angle. Based on this assumption, we derive the rotational stiffness of the disc, which is considered equal to the rotational stiffness of the leaf springs section (R_0 to R_1), as described below.

$$Rotational stiffness = {K}_{θ} = \frac{T}{θ} = \frac{12 \times E \times {I}_{ZZ} \times n}{{L}^{3}}$$

moment of inertia in the thickness direction of the leaf spring
w=spring width
t=leaf spring thickness
E=modulus of elasticity of the material
1=R_1−R_0 spring length
n=number of springs

Stress in the spring due to the friction torque is calculated as follows,

$${σ}_{y} = \frac{6 \times T \times l \times w \times E}{{K}_{θ} \times {l}^{3} \times {R}_{1} \times n}$$

Where, T is the torque due to friction because of electroadhesion. σ_y is the maximum allowable stress before the material yields and is equal to σ_max, and

$${ϵ}_{y} = \frac{{σ}_{y}}{E}$$

Thus, the relation between the rotational stiffness and applicable torque is calculated as below.

$${K}_{θ} = T \times \frac{6 \times l \times w}{{l}^{3} \times {R}_{1} \times n} \times \frac{1}{{ϵ}_{y}}$$

ϵ_y is a constant for each material ranging from 2.78× [symbol] 10 [symbol] \hat{ }(−3) for a stiff conductor material such as spring steel to 5.98× [symbol] 10 [symbol] \hat{ }(−4) for a soft conductor material such as copper. Table 9 below shows ϵ_y for a range of material that could be used as a disc substrates and includes metalized polyester film as a further comparison.

TABLE 9
comparison of material properties for illustrative disc materials.

| | E [GPa] | σ_{y} [MPa] | ${ϵ}_{y} = \frac{{σ}_{y}}{E}$ |
|---|---|---|---|
| 1059 Spring Steel | 205 | 570 | 2.78 × 10⁻³ |
| 316 Stainless Steel | 193 | 530 | 2.74 × 10⁻³ |
| Brass | 102 | 250 | 2.09 × 10⁻³ |
| Aluminum | 69 | 96 | 1.39 × 10⁻³ |
| Copper | 117 | 70 | 5.98 × 10⁻⁴ |
| Metalized Polyester | 1.57-5.20 | 5.52-147 | 3.52 × 10⁻³ to |
| Film | | | 28.27 × 10⁻³ |

A relationship of rotational stiffness (K_θ) to axial stiffness K_a can be understood by considering various examples of design parameters using the illustrative materials listed in Table 9. For example, an estimated range for K_theta/K_a, according to materials listed in Table 9 and some possible selected design parameters (n, w, 1, and R_1) could be 50 to 8000 (i.e., in this example a flexible disc has at least 50 times greater rotational stiffness than axial stiffness). In another example, considering the materials in Table 9 other than Metalized Polyester Film, an estimated range for K_theta/K_a, according to some possible selected design parameters (n, w, 1, and R_1) could be 500 to 8000 (i.e., in this example a flexible disc has at least 500 times greater rotational stiffness than axial stiffness).

In another example of variation, not all contact surfaces at an electroadhesion interface need be layered with a dielectric material. In certain examples, one of the contact surfaces is a dielectric material. In other examples, two of the contact surfaces are dielectric material.

In another example of variation, the number of alternations of the electric field imposed by a polarity modulator may be varied to suit a particular implementation. Alternation of the electric field by a polarity modulator, will result in a plurality of alternations per revolution (ie., per full-360-degree rotation of the contact surfaces) of corresponding contact surfaces in a contact pair, or more complex contact configurations such as a contact triplet. Thus, at least two alternations of the electric field will occur for each full-360-degree rotation of the contact surfaces.

When it comes to the frequency of the electric field's alternation, there is a distinction between segmented discs compared to alternating current or pulse width modulation (PWM). For segmented discs, the number of electric field alternations is constant with respect to the number of revolutions. This number of alternations per revolution equals the number of segments, ranging from a minimum of two to a maximum of nearly 72. In this case, the number of alternation per time increases with velocity of rotation. In contrast, in the case of alternating current, the number of electric field alternations remains constant with respect to time. This number is determined by the frequency of the current's alternation. In theory, there's no lower limit for this frequency. However, in practice, frequencies below 100 Hz, or perhaps even below 200 Hz may be avoided because they cause vibrations in the clutch that may be noticeable. On the other hand, high frequencies lead to increased power consumption, which is not ideal. The power consumption-frequency of alternation relationship is shown for example in FIG. 12. Frequencies above 200 Hz can reduce the vibration problem and frequencies below 700 Hz can avoid impractically high power consumption. It is worth noting that frequencies between 300 to 800 Hz were found to be useful in terms of minimizing vibration and power consumption. Although, the segmentation fixes alternation per revolution, and AC and PWM fixes alternation to unit time, the AC or PWM frequency can be adjusted/selected so that multiple alternation events occur per revolution.

The vibration problem at lower alternation frequencies of AC and PWM signals was identified during experimental testing of rotary electroadhesive clutch implementations. Beyond the consideration of power consumption, which can be used to delineate an upper threshold for applicable alternation frequencies when employing AC and PWM signals, we can also account for vibrations and noise stemming from these alternations, setting a lower bound on the frequency range. Our analysis focused on the vibrational characteristics of the clutch disc, utilizing discs identical to those deployed in the Experimental Examples, and meticulously determining the natural frequencies of both rotor and stator discs. Additionally, we executed the clutch activation within a frequency spectrum spanning 50 to 700 Hz, meticulously recording the acoustic emissions engendered by the clutch, attributed to vibrational responses originating from the electric field alternation. As shown in FIG. 51, multiple natural frequencies, highlighted by grey dashed lines, manifest below the 200 Hz threshold. Moreover, the pronounced concentration of frequency components beneath 200 Hz, marked by spikes in the continuous black plot, signifies the triggering of natural frequencies beneath this critical threshold. The identical trend is observable in FIG. 52, depicting the recorded sound pressure level in relation to the frequency of activation. Notably, the sound pressure level exhibits an ascending trajectory as the frequency diminishes below the 200 Hz threshold. The segmented discs provide a benefit/advantage of reducing, and even avoiding, the vibration problem. The vibration problem was not observed in the experimental setups of segmented discs tested in Experimental Example 3.

While three examples of polarity modulators of alternating current, pulse width modulation (PWM) of direct current and structurally segment discs have been provided that are capable of alternating the applied electric field at least two times per revolution, the structurally segmented discs confer an advantage of the alternation of electric field being relatively local and gradual that avoids vibration that occurs from the relatively sudden flipping of electric field that occurs at the entire electroadhesion interface by alternating current or pulse width modulation.

Of further note, is that PWM confers an advantage over alternating current. The PWM approach was explored in Experimental Example 2, which demonstrated that the electroadhesion force can be controlled by adjusting the duty cycle of the input signal rather than its amplitude, as is the case with general alternating current sources. PWM offers several advantages, including easier digital control of the clutch (or brake, depending on configuration of electroadhesive interacting plates) and a faster response time, as it eliminates the complexities associated with high voltage boosters in a control loop.

For examples of the structurally segmented discs described in Experimental Example 3, two alternations of an electric field are achieved by two segments, each of an opposing polarity, and in an example of a symmetrical circular configuration each segment will be span approximately, but slightly less than 180 degrees with a non-conductive strip or gap separating the two segments to electrically isolate the two segments. The two segments need not be symmetrical, and asymmetrical configurations are contemplated, including for example a first segment covering a greater surface area or having a different shape than a second segment. A maximum number of segments will depend upon machining or manufacturing precision. In an example of a symmetrical circular configuration, a maximum number of segments may be set at 72, with each segment spanning approximately 5 degrees while accommodating a non-conductive gap bordering each segment to electrically isolate each segment from all other segments. A greater or lesser maximum number of segments may be determined to suit a particular implementation. Both symmetrical and asymmetrical configurations of segments are contemplated, regardless of the number of segments. Thus, the size of segments need not be constant and may vary within the set of segments disposed on a single plate. Shape of segments need not be wedge shaped arcs, and may be any desired shape including for example square or circular shapes.

As another example of variation, the electroadhesion control of rotary motion is readily adaptable to a clutch implementation or a brake implementation. A typical distinction between the clutch and brake implementation is that in a typical clutch implementation both contact surfaces are rotatable with a first contact surface rotationally-fixed to an output or driven shaft and a second contact surface rotationally-fixed to an input or driver shaft, while in a typical brake implementation one of the contact surfaces is not rotatable and is grounded to be in a stationary position. In an example of further variation, a clutch and brake may be provided in the same implementation; electric activation circuitry to actuate the clutch and brake may be separate independent circuits or a single circuit with a switch between the clutch and brake.

As another example of variation, the housing or casing of the electroadhesion mechanism can accommodate any desired shape or size variation. Furthermore, the housing or casing may be moved or adjusted or rotated or may be expanded or contracted as desired to suit a particular implementation.

As another example of variation, electroadhesion force at the electroadhesion interface may be adjusted or tuned by changing any convenient parameter of the applied electric field including for example a change of voltage, change of current, change of duty cycle, a change of voltage amplitude, a change of current amplitude, a change of voltage frequency, a change of current frequency, and the like.

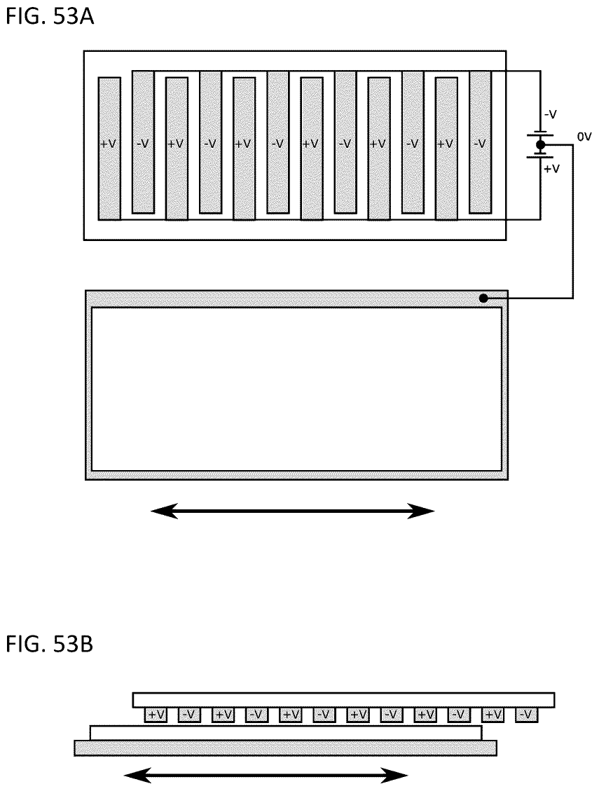

As another example of variation, the segmented electro-adhesive clutch/brake demonstrated in a rotational configuration in Experimental Example 3, can also be applied in a linear configuration. In this linear setup, one of the plates is constructed using an insulator substrate featuring two categories of conductor plates: positively charged (with positive voltage) segments and negatively charged (with negative voltage) segments. The positively charged segments are electrically interconnected within the plate, as are the negatively charged segments. On the other side, the second plate consists of a conductor substrate coated with a thin dielectric layer, and the conductor substrate is grounded to zero voltage. These two plates are stacked together with a gentle pressing force, ensuring there is no gap between them. This pressing force can be generated, for example, using a spring-loaded pressure plate or by wedging the clutch plates between two permanent magnet plates. When a positive and negative voltage is applied across the segments, electroadhesion attraction comes into play between the segmented plate and the uniform plate. This interaction leads to the buildup of friction between the plates and facilitates the transfer of force from the driving plate to the driven plate. The direction of motion aligns with the placement of the segments (i.e., the direction of alternation of the sequence of positive and negative segments is generally parallel to the direction of motion), as depicted in FIG. 53A and FIG. 53B. Notably, the periodic alteration of the electric field resulting from the segmented design prevents the accumulation of space charge within the dielectric. This, in turn, eliminates electroadhesion degradation and residual electroadhesion, similar to what is achieved in the rotary configuration. Furthermore, similar to the rotary configuration, the linear configuration allows for the use of multiple layers of clutch plates arranged in parallel, which effectively enhances the capacity of the clutch.

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

1.-67. (canceled)

68. A device for electroadhesion control of rotary motion, the device comprising:
a shaft;
a first plate and second plate coupled to the shaft, a first surface of the first plate aligned in substantially parallel facing opposition to a second surface of the second plate, the first surface and second surface forming a dry sliding friction contact pair that defines an electroadhesion interface therebetween;
a dielectric material disposed on at least one of the first surface or the second surface;
the contact pair of the first surface and second surface exhibiting electroadhesion based in part on a sufficient electrical field generated across the contact pair and the electroadhesion interface to achieve electrostatic attraction between the contact pair to cause a frictional force therebetween;
a polarity modulator alternating the electrical field multiple times per revolution of the contact pair;
a third plate exerting a constant pressure on at least one of the first plate or the second plate to bias the first and second plate towards each other.

69. The device of claim 68, wherein the polarity modulator is a source of an alternating current activation signal.

70. The device of claim 68, wherein the polarity modulator is a source of pulse width modulation activation signal providing alternating pulses of negative and positive voltage.

71. The device of claim 68, wherein the polarity modulator is a segmentation of at least one of the first surface or the second surface into a plurality of segments having alternating positive and negative charge.

72. The device of claim 71, wherein each segment of the plurality of segments is bound by a first radial line and a second radial line, the first and second radial lines are separated by at least 5 degrees.

73. The device of claim 71, wherein each segment of the plurality of segments is electrically isolated from all other segments of the plurality of segments by a non-conductive gap between each neighboring/adjacent pair of the plurality of segments.

74. The device of claim 71, wherein segments having positive charge are electrically communicative and segments having negative charge are electrically communicative, while the segments having positive charge are electrically isolated from the segments having negative charge.

75. The device of claim 71, wherein the plurality of segments is at least 4 segments.

76. The device of claim 71, wherein the third plate is connected to the at least one of the first plate or the second plate by a resilient member.

77. The device of claim 71, wherein the third plate comprises a first magnet and the at least one of the first plate or the second plate comprises a ferromagnetic material.

78. The device of claim 77, wherein the third plate is the first magnet and a second magnet is attached to the at least one of the first plate or the second plate.

79. The device of claim 71, wherein the at least one of the first plate and the second plate slides along an axial length of the shaft.

80. The device of claim 71, wherein the at least one of the first plate and the second plate is positionally-fixed to the shaft and is flexible and bends due to the constant pressure.

81. The device of claim 80, wherein the at least one of the first plate and the second plate comprises a plurality of leaf springs coupling a respective at least one of the first surface or the second surface to the shaft.

82. The device of claim 80, wherein a rotational stiffness of the at least one of the first plate and the second plate is at least 50 times greater than an associated axial stiffness.

83. The device of claim 68, wherein electroadhesion of the first surface and second surface is adjustable by changing a duty cycle of an applied voltage.

84. The device of claim 68, wherein electroadhesion of the first surface and second surface is adjustable by changing a magnitude of an applied voltage.

85. The device of claim 68, configured as a clutch.

86. The device of claim 68, configured as a brake.

87. A robot comprising:
the device of claim 71, wherein the device controls transmission of torque from an actuator input to a rotational joint output,
a torque sensor measuring output torque data from the device;
a robust controller adjusting electroadhesion of the contact pair based on the output torque data.
